(19) United States
(12) Patent Application Publication
(10) Pub. No.: US 2025/0171955 A1
(43) Pub. Date: May 29, 2025

(54) Recording Method

(71) Applicant: SEIKO EPSON CORPORATION, Tokyo (JP)

(72) Inventor: Kosuke CHIDATE, Shiojiri (JP)

(21) Appl. No.: 18/959,762

(22) Filed: Nov. 26, 2024

(30) Foreign Application Priority Data
Nov. 27, 2023 (JP) 2023-199656

(51) Int. Cl. D06P 5/30; B41J 3/407; D06M 15/643; D06M 23/16; D06M 101/06; D06M 101/32; D06P 1/52; D06P 1/673; D06P 1/90; D06P 3/60; D06P 5/20

(52) U.S. Cl. CPC D06P 5/30; D06M 15/643; D06M 23/16; D06P 3/60; D06P 5/2077; B41J 3/4078; D06M 2101/06; D06M 2101/32; D06M 2200/50; D06P 1/5285; D06P 1/673; D06P 1/90

(57) ABSTRACT

A recording method includes a color ink deposition step of depositing an ink composition containing a pigment, resin particles, and water onto a recording medium by an ink jet method to form an image region, a first treatment liquid deposition step of depositing a first treatment liquid composition containing resin particles and water onto the recording medium by an ink jet method, and a second treatment liquid deposition step of depositing a second treatment liquid composition containing a softening agent onto the recording medium by an ink jet method, in which the image region has regions with different ink deposition amounts per unit area, the first treatment liquid deposition step and the second treatment liquid deposition step are carried out for at least the entire image region, and the deposition amount of the first treatment liquid composition is 12 mL/m² or more.

The present application is based on, and claims priority from JP Application Serial Number 2023-199656, filed Nov. 27, 2023, the disclosure of which is hereby incorporated by reference herein in its entirety.

### BACKGROUND

### 1. Technical Field

The present disclosure relates to a recording method.

### 2. Related Art

Ink jet methods are not only used for recording an image on paper or the like, but there has also been an attempt to apply ink jet methods in textile printing on fabric, and various types of ink jet textile printing have been studied. An ink jet ink for textile printing contains a coloring material in order to obtain an image with a desired color, and a dye or a pigment is used as the coloring material. In addition, also in ink jet textile printing, many studies have been conducted on inks and recording methods.

For example, JP-A-2022-003174 discloses a textile printing device in which the ink discharge amount per unit area and the pretreatment liquid discharge amount per unit area are each made constant in every portion of a specific region or are each made different in each portion of the specific region, with the ratio therebetween made constant in every portion of the specific region. JP-A-2022-003174 indicates that the textile printing device can form a textile printed matter excellent in image density and wet friction fastness while suppressing deterioration in texture of the textile printed matter.

JP-A-2022-003174 indicates that the pretreatment liquid contains water and binder resin particles including a cationic resin, the ink contains a pigment, an anionic dispersant, and water, and the posttreatment liquid contains a lubricant and water. However, in the technique described in JP-A-2022-003174, an image distortion may occur due to the binder resin particles. Therefore, there is a need for a recording method with which fastness and texture of a recorded matter obtained are good and an image distortion is reduced.

### SUMMARY

An aspect of a recording method according to the present disclosure includes a color ink deposition step of depositing an ink composition containing a pigment, resin particles, and water onto a recording medium by an ink jet method to form an image region, a first treatment liquid deposition step of depositing a first treatment liquid composition containing resin particles and water onto the recording medium by an ink jet method, and a second treatment liquid deposition step of depositing a second treatment liquid composition containing a softening agent onto the recording medium by an ink jet method, in which the image region has regions with different ink deposition amounts per unit area, the first treatment liquid deposition step and the second treatment liquid deposition step are carried out for at least the entire image region, and the deposition amount of the first treatment liquid composition is 12 mL/m² or more.

### BRIEF DESCRIPTION OF THE DRAWINGS

FIG. 1 is a schematic diagram illustrating an overview configuration of a recording device applicable to a recording method according to an embodiment.

FIG. 2 is a schematic diagram of a printing pattern in Examples and the like.

FIG. 3 is Table 1 showing conditions and evaluation results of Examples.

FIG. 4 is Table 2 showing conditions and evaluation results of Examples.

FIG. 5 is Table 3 showing conditions and evaluation results of Examples and Comparative Examples.

### DESCRIPTION OF EMBODIMENT

Hereinafter, an embodiment of the present disclosure will be described. The embodiment described below explains an example of the present disclosure. The present disclosure is not limited to the following embodiment, and includes various modifications that are carried out within a range not changing the spirit of the present disclosure. Note that not all of constituents described below are essential constituents of the present disclosure.

### 1. Recording Method

A recording method according to the present embodiment includes a color ink deposition step, a first treatment liquid deposition step, and a second treatment liquid deposition step.

### 1. 1. Color Ink Deposition Step

In the color ink deposition step, an ink composition containing a pigment, resin particles, and water is deposited onto a recording medium by an ink jet method to form an image region.

### 1. 1. 1. Recording Medium

The recording medium to which the recording method of the present embodiment can be applied is not particularly limited. The recording medium may or may not have a recording surface that absorbs ink. Accordingly, the recording medium is not particularly limited, and examples thereof include liquid absorbent recording media such as paper, a film, and fabric, liquid low-absorbent recording media such as printing paper, and liquid non-absorbent recording media such as a metal, glass, and a polymer. When a flexible recording medium is used among these recording media, a significant effect is provided. That is, when paper, a film, fabric, printing paper, or a thin-film metal such as aluminum foil is used among the recording media, a significant effect is provided.

In the recording method of the present embodiment, when fabric is used among the recording media, a more significant effect is provided. That is, fabric is a medium having absorbency and stretchability and is more likely to cause an image distortion; however, when fabric is used, the effect of reducing distortion can be more significantly provided. For the same reason, it is more preferable to use cotton fabric as the fabric.

The fabric is not particularly limited. A material constituting the fabric is not particularly limited, and examples thereof include natural fibers such as cotton, hemp, wool, and silk; synthetic fibers such as polypropylene, polyester, acetate, triacetate, polyamide, and polyurethane; and biodegradable fibers such as polylactic acid. The material constituting the fabric may be mixed fibers thereof. As the fabric, the above-described fibers may be used in any form, such as woven fabric, knitted fabric, or nonwoven fabric, and may be mixed and used.

The fabric may be the above-described fibers in any form of woven fabric, knitted fabric, nonwoven fabric, or the like. The basis weight of the fabric used in the present embodiment is also not particularly limited, and may be 1.0 oz or more and 10.0 oz or less, preferably 2.0 oz or more and 9.0 oz or less, more preferably 3.0 oz or more and 8.0 oz or less, and still more preferably 4.0 oz or more and 7.0 oz or less. When the basis weight of the fabric falls within such a range, better recording can be performed.

In the present embodiment, examples of the form of the fabric include fabric, clothing, and other furnishings. The fabric includes woven fabric, knitted fabric, nonwoven fabric, and the like. Clothing and other furnishings include sewn products such as T-shirts, handkerchiefs, scarfs, towels, tote bags, fabric bags, curtains, sheets, bed covers, and furniture such as wallpaper, as well as fabric before or after cutting as parts before sewing. Examples of forms thereof include long fabric wound in a roll form, a piece of fabric cut into a predetermined size, and fabric having a final product shape.

### 1. 1. 2. Image Region

The image region refers to a region where the ink composition is deposited onto the recording medium in the color ink deposition step. Although the shape, the size, and the number of image regions are appropriately selected, the image region has regions with different ink composition deposition amounts per unit area. That is, a region with a large ink composition deposition amount and a region with a small ink composition deposition amount are formed, and the entirety thereof forms the image region.

### 1. 1. 3. Ink Composition

Hereinafter, the ink composition will be described. A method of depositing the ink composition onto the recording medium or the like will be described later. The ink composition contains a pigment, resin particles, and water.

### 1. 1. 3. (1) Pigment

The ink composition is a so-called color ink containing a pigment. The pigment contained in the ink composition may be a color pigment such as cyan, yellow, magenta, black, red, green, or orange or a spot color pigment such as white, for example.

The pigment may be a mixture. The pigment is preferably excellent in preservation stability such as light resistance, weather resistance, and gas resistance and is preferably an organic pigment from such viewpoints.

Specifically, an azo pigment such as an insoluble azo pigment, a condensed azo pigment, azo lake, or a chelated azo pigment; a polycyclic pigment such as a phthalocyanine pigment, a perylene pigment, a perinone pigment, an anthraquinone pigment, a quinacridone pigment, a dioxane pigment, a thioindigo pigment, an isoindolinone pigment, or a quinophthalone pigment; a dye chelate; dye lake; a nitro pigment; a nitroso pigment; aniline black; a daylight fluorescent pigment; or carbon black is used as the pigment. One kind of the pigment may be used singly or two or more kinds thereof may be used in combination. Furthermore, a white pigment, a glittering pigment, or the like may be used as the pigment.

Specific examples of the pigment are not particularly limited and include the following pigments.

Examples of a black pigment include Bonjetblack CW-1 (manufactured by ORIENT CHEMICAL INDUSTRIES CO., LTD.), No. 2300, No. 900, MCF88, No. 33, No. 40, No. 45, No. 52, MA7, MA8, MA100, and No. 2200B (all of the above are manufactured by Mitsubishi Chemical Corporation); Raven 5750, Raven 5250, Raven 5000, Raven 3500, Raven 1255, and Raven 700 (all of the above are manufactured by Carbon Columbia corporation), Regal 400R, Regal 330R, Regal 660R, Mogul L, Monarch 700, Monarch 800, Monarch 880, Monarch 900, Monarch 1000, Monarch 1100, Monarch 1300, and Monarch 1400 (all of the above are manufactured by CABOT JAPAN K. K.); and Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, and Special Black 4 (all of the above are manufactured by Degussa AG).

Examples of a yellow pigment include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of a magenta pigment include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48(Ca), 48(Mn), 57(Ca), 57:1, 88, 112, 114, 122, 123, 144, 146, 149, 150, 166, 168, 170, 171, 175, 176, 177, 178, 179, 184, 185, 187, 202, 209, 219, 224, and 245, and C.I. Pigment Violet 19, 23, 32, 33, 36, 38, 43, and 50.

Examples of a cyan pigment include C.I. pigment blue 1, 2, 3, 15, 15:1, 15:2, 15:3, 15:34, 15:4, 16, 18, 22, 25, 60, 65, and 66, and C.I. Vat Blue 4 and 60.

Examples of a pigment other than magenta, cyan, and yellow are not particularly limited but include C. I. Pigment Green 7 and 10, C.I. Pigment Brown 3, 5, 25, and 26, and C.I. Pigment Orange 1, 2, 5, 7, 13, 14, 15, 16, 24, 34, 36, 38, 40, 43, and 63.

Examples of a white pigment include metal compounds such as a metal oxide, a barium sulfate, and calcium carbonate. Examples of the metal oxide include titanium dioxide, zinc oxide, silica, alumina, and magnesium oxide. As the white pigment, particles having a hollow structure may be used, and known particles can be used as the particles having a hollow structure.

It is preferable that the pigment be able to be stably dispersed in a dispersion medium, and the pigment may be dispersed using a dispersant for this purpose. The dispersant includes a resin dispersant and the like, and is selected from those capable of improving dispersion stability of the pigment in the ink composition. In addition, surfaces of pigment particles may be modified through oxidation or sulfonation using ozone, hypochlorous acid, fuming sulfuric acid, or the like, for example, and the surface-modified pigment may be used as a self-dispersing pigment. The self-dispersing pigment is not a pigment dispersed by a dispersant or the like but is a self-dispersing pigment that can be dispersed without using a dispersant or the like. As the self-dispersing pigment contained in the ink composition, a color pigment such as black, cyan, yellow, magenta, red, green, or orange, or a spot color pigment such as white, which can be self-dispersed through an appropriate treatment, can be used.

Examples of the resin dispersant (dispersant resin) include (meth)acrylic resins such as poly(meth)acrylic acid, a (meth)acrylic acid-acrylonitrile copolymer, a (meth)acrylic acid-(meth)acrylic acid ester copolymer, a vinyl acetate-(meth)acrylic acid ester copolymer, a vinyl acetate-(meth)acrylic acid copolymer, and a vinylnaphthalene-(meth)acrylic acid copolymer, and salts thereof; styrene-based resins such as a styrene-(meth)acrylic acid copolymer, a styrene-(meth)acrylic acid-(meth)acrylic acid ester copolymer, a styrene-α-methylstyrene-(meth)acrylic acid copolymer, a styrene-α-methylstyrene-(meth)acrylic acid-(meth)acrylic acid ester copolymer, a styrene-maleic acid copolymer, and a styrene-maleic anhydride copolymer, and salts thereof; urethane-based resins, which are polymer compounds (resins) containing a urethane bond obtained through reaction between an isocyanate group and a hydroxy group, may be linear and/or branched, and may have or may not have a crosslinked structure, and salts thereof; polyvinyl alcohols; vinylnaphthalene-maleic acid copolymers and salts thereof; vinyl acetate-maleic acid ester copolymers and salts thereof; and water-soluble resins such as vinyl acetate-crotonic acid copolymers and salts thereof. Among them, a copolymer of a monomer having a hydrophobic functional group and a monomer having a hydrophilic functional group, and a polymer composed of a monomer having both a hydrophobic functional group and a hydrophilic functional group are preferable. As the form of the copolymer, any of a random copolymer, a block copolymer, an alternating copolymer, and a graft copolymer can be used.

Examples of commercially available styrene-based resin dispersants include X-200, X-1, X-205, X-220, and X-228 (manufactured by SEIKO PMC CORPORATION), NOPCOSPERSE (registered trademark) 6100 and 6110 (manufactured by SAN NOPCO LIMITED), JONCRYL 67, 586, 611, 678, 680, 682, and 819 (manufactured by BASF SE), DISPERBYK-190 (manufactured by BYK Japan KK), and N-EA137, N-EA157, N-EA167, N-EA177, N-EA197D, N-EA207D, and E-EN10 (manufactured by DKS Co. Ltd.).

Examples of commercially available acrylic resin dispersants include BYK-187, BYK-190, BYK-191, BYK-194N, and BYK-199 (manufactured by BYK Japan KK), and Aron A-210, A6114, AS-1100, AS-1800, A-30SL, A-7250, and CL-2 (manufactured by TOAGOSEI CO., LTD.).

Examples of commercially available urethane-based resin dispersants include BYK-182, BYK-183, BYK-184, and BYK-185 (manufactured by BYK Japan KK), TEGO Disperse 710 (manufactured by Evonic Tego Chemie GmBH), and Borchi (registered trademark) Gen 1350 (manufactured by OMG Borchers GmBH).

One kind of the dispersant may be used singly or two or more kinds thereof may be used in combination. The total content of the dispersant is preferably 0.1 parts by mass or more and 30 parts by mass or less, more preferably 0.5 parts by mass or more and 25 parts by mass or less, still more preferably 1 part by mass or more and 20 parts by mass or less, and even more preferably 1.5 parts by mass or more and 15 parts by mass or less, based on 50 parts by mass of the pigment. When the content of the dispersant is 0.1 parts by mass or more based on 50 parts by mass of the pigment, dispersion stability of the pigment can be further enhanced. When the content of the dispersant is 30 parts by mass or less based on 50 parts by mass of the pigment, the viscosity of a dispersion obtained can be kept low.

Among the examples of the dispersant shown above, it is further preferable that the dispersant be at least one selected from anionic dispersant resins. In this case, the weight average molecular weight of the dispersant is more preferably 500 or more. The weight average molecular weight of the dispersant is still more preferably 5000 or more and 100000 or less, and even more preferably 10000 or more and 50000 or less.

By using such a resin dispersant as the dispersant, dispersion and aggregating properties of the pigment are improved, and better dispersion stability and an image with better image quality can be obtained.

An anionic dispersant resin is a resin having an anionic functional group and exhibits anionic properties. Examples of the anionic functional group include a carboxy group, a sulfo group, and a phosphate group. Among these groups, a carboxy group is more preferable.

The dispersant resin preferably has an acid value of 5 mgKOH/g or more, more preferably 10 to 200 mgKOH/g, and still more preferably 15 to 150 mgKOH/g. The acid value is even more preferably 20 to 100 mgKOH/g and further preferably 25 to 70 mgKOH/g.

The acid value can be measured by neutralization potentiometric titration in accordance with JIS K0070. As the titrator, for example, “AT610” manufactured by Kyoto Electronics Manufacturing Co., Ltd. can be used.

The content of the pigment is preferably 0.3% by mass or more and 20% by mass or less and more preferably 0.5% by mass or more and 15% by mass or less, based on the total mass of the ink composition. The content of the pigment is still more preferably 1% by mass or more and 10% by mass or less and even more preferably 2% by mass or more and 7% by mass or less.

The volume average particle diameter of particles of the pigment is preferably 10 nm or more and 300 nm or less, more preferably 30 nm or more and 250 nm or less, still more preferably 50 nm or more and 250 nm or less, and particularly preferably 70 nm or more and 200 nm or less. The volume average particle diameter of particles of the pigment is further preferably 80 nm or more and 150 nm or less.

### 1. 1. 3. (2) Resin Particles

The ink composition contains resin particles. The resin particles can further improve adhesion of an image formed by the ink composition deposited onto the recording medium. Examples of the resin particles include anionic resin particles among resin particles made of a urethane-based resin, an acrylic resin (including a styrene acrylic resin), a fluorene-based resin, a polyolefin-based resin, a rosin-modified resin, a terpene-based resin, a polyester-based resin, a polyamide-based resin, an epoxy-based resin, a vinyl chloride-based resin, a vinyl chloride-vinyl acetate copolymer, an ethylene vinyl acetate-based resin, and the like. Among them, a urethane resin, an acrylic resin, a polyolefin-based resin, and a polyester-based resin are preferable. These resin particles are often handled in an emulsion form, but may be in a powder form. One kind of the resin particles may be used singly, or two or more kinds thereof may be used in combination.

Among them, the resin particles are more preferably a urethane resin. When a urethane resin is selected, an image having further excellent friction fastness can be formed.

The urethane-based resin is a generic term for a resin having a urethane bond. As the urethane-based resin, a polyether-type urethane resin including an ether bond in the main chain in addition to a urethane bond, a polyester-type urethane resin including an ester bond in the main chain in addition to a urethane bond, a polycarbonate-type urethane resin including a carbonate bond in the main chain in addition to a urethane bond, or the like may be used. In addition, as the urethane-based resin, a commercially available product such as SUPERFLEX 460, 460s, 500M, 840, or E-4000 (product names, manufactured by DKS Co. Ltd.), REZAMINE D-1060, D-2020, D-4080, D-4200, D-6300, or D-6455 (product names, manufactured by Dainichiseika Color & Chemicals Mfg. Co., Ltd.), TAKELAC WS-6021 or W-512-A-6 (product names, manufactured by Mitsui Chemicals Polyurethanes, Inc.), Sancure 2710 (product name, manufactured by The Lubrizol Corporation), or PERMARIN UA-150 (product name, manufactured by Sanyo Chemical Industries, Ltd.) may be used.

The acrylic resin is a generic name of a polymer obtained by polymerizing at least an acrylic monomer such as (meth)acrylic acid or a (meth)acrylic acid ester as one component, and examples thereof include a resin obtained from an acrylic monomer, and a copolymer of an acrylic monomer and a monomer other than acrylic monomers. For example, the acrylic resin includes an acrylic-vinyl resin which is a copolymer of an acrylic monomer and a vinyl monomer. Examples of the vinyl monomer include styrene.

As the acrylic monomer, acrylamide, acrylonitrile, or the like can also be used. As a resin emulsion using the acrylic resin as a raw material, a commercially available product may also be used, and for example, a product selected from FK-854 (product name, manufactured by CHUORIKA KOUGYO Co., Ltd.), Mowinyl 952B, 718A, and 6760 (product names, manufactured by the Nippon Synthetic Chemical Industry Co., Ltd.), Nipol LX852 and LX874 (product names, manufactured by Zeon Corporation), and the like may be used.

In the present specification, the acrylic resin may be a styrene-acrylic resin described later. In the present specification, the term “(meth)acrylic” means at least one of acrylic and methacrylic.

The styrene-acrylic resin is a copolymer obtained from a styrene monomer and a (meth)acrylic monomer, and examples thereof include a styrene-acrylic acid copolymer, a styrene-methacrylic acid copolymer, a styrene-methacrylic acid-acrylic acid ester copolymer, a styrene-α-methylstyrene-acrylic acid copolymer, and a styrene-α-methylstyrene-acrylic acid-acrylic acid ester copolymer. As the styrene-acrylic resin, a commercially available product may be used, and JONCRYL 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, or 7610 (product names, manufactured by BASF SE), Mowinyl 966A or 975N (product names, manufactured by the Nippon Synthetic Chemical Industry Co., Ltd.), VINYBLAN 2586 (manufactured by Nissin Chemical Industry Co., Ltd.), or the like may be used, for example.

The polyolefin-based resin has an olefin such as ethylene, propylene, or butylene as the structural skeleton thereof, and a known polyolefin-based resin can be appropriately selected and used. As the olefin resin, a commercially available product can be used, and ARROWBASE CB-1200 or CD-1200 (product names, manufactured by UNITIKA LTD.), or the like may be used, for example.

The resin particles may be supplied in an emulsion form, and examples of commercially available products of such a resin emulsion used may be selected from MICROGEL E-1002 and E-5002 (product names, manufactured by Nippon Paint Co., Ltd., styrene-acrylic resin emulsion), VONCOAT 4001 (product name, manufactured by DIC Corporation, acrylic resin emulsion), VONCOAT 5454 (product name, manufactured by DIC Corporation, styrene-acrylic resin emulsion), POLYSOL AM-710, AM-920, AM-2300, AP-4735, AT-860, and PSASE-4210E (acrylic resin emulsion), POLYSOL AP-7020 (styrene acrylic resin emulsion), POLYSOL SH-502 (vinyl acetate resin emulsion), POLYSOL AD-13, AD-2, AD-10, AD-96, AD-17, and AD-70 (ethylene-vinyl acetate resin emulsion), POLYSOL PSASE-6010 (ethylene-vinyl acetate resin emulsion) (product name, manufactured by Showa Denko K. K.), POLYSOL SAE1014 (product name, styrene-acrylic resin emulsion, manufactured by Zeon Corporation), Saibinol SK-200 (product name, acrylic resin emulsion, manufactured by SAIDEN CHEMICAL INDUSTRY CO., LTD.), AE-120A (product name, acrylic resin emulsion, manufactured by JSR Corporation), AE373D (product name, carboxy-modified styrene-acrylic resin emulsion, manufactured by Emulsion Technology Co., Ltd.), SEIKADYNE 1900W (product name, ethylene-vinyl acetate resin emulsion, manufactured by Dainichiseika Color & Chemicals Mfg. Co., Ltd.), VINYBLAN 2682 (acrylic resin emulsion), VINYBLAN 2886 (vinyl acetate-acrylic resin emulsion), VINYBLAN 5202 (acrylic acetate resin emulsion) (product name, manufactured by Nissin Chemical Industry Co., Ltd.), ELITEL KA-5071S, KT-8803, KT-9204, KT-8701, KT-8904, and KT-0507 (product names, polyester resin emulsion, manufactured by UNITIKA LTD.), High-tech SN-2002 (product name, polyester resin emulsion, manufactured by TOHO Chemical Industry Co., Ltd.), TAKELAC W-6020, W-635, W-6061, W-605, W-635, and W-6021 (product names, urethane-based resin emulsion, manufactured by Mitsui Chemicals Polyurethanes, Inc.), SUPERFLEX 870, 800, 150, 420, 460, 470, 500M, 610, and 700 (product names, urethane-based resin emulsion, manufactured by DKS Co. Ltd.), PERMARIN UA-150 (urethane-based resin emulsion, manufactured by Sanyo Chemical Industries, Ltd.), Suncure 2710 (urethane-based resin emulsion, manufactured by Lubrizol Japan Limited), NeoRez R-9660, R-9637, and R-940 (urethane-based resin emulsion, manufactured by Kusumoto Chemicals, Ltd.), ADEKA BONTIGHTER HUX-380 and 290K (urethane-based resin emulsion, manufactured by ADEKA CORPORATION), Mowinyl 966A and Mowinyl 7320 (manufactured by the Nippon Synthetic Chemical Industry Co., Ltd.), JONCRYL 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (all of the above are manufactured by BASF SE), NK Binder R-5HN (manufactured by SHIN-NAKAMURA CHEMICAL Co., Ltd.), HYDRAN WLS-210 (non-crosslinkable polyurethane: manufactured by DIC Corporation), JONCRYL 7610 (manufactured by BASF SE), and the like.

The content of the resin particles in the ink composition is 0.1% by mass or more and 20% by mass or less, preferably 1% by mass or more and 15% by mass or less, more preferably 3% by mass or more and 7% by mass or less, and particularly preferably 3% by mass or more and 5% by mass or less, in terms of solid content based on the total mass of the ink composition.

### 1. 1. 3. (3) Water

The ink composition contains water. Examples of the type of water include pure water such as ion-exchanged water, ultrafiltered water, reverse osmosis water, and distilled water, and water from which ionic impurities are removed as much as possible, such as ultrapure water. In addition, when water sterilized by ultraviolet irradiation, addition of hydrogen peroxide, or the like is used, occurrence of bacteria and fungi can be reduced when the composition is stored for a long period of time.

The content of water is 30% by mass or more, preferably 40% by mass or more, more preferably 45% by mass or more, and still more preferably 50% by mass or more, based on the total amount of the ink composition. Note that when water in the ink composition is referred, crystal water contained in a raw material substance and water to be added are included, for example. When the content of water is 30% by mass or more, the ink composition can have a relatively low viscosity. The upper limit of the water content is preferably 90% by mass or less, more preferably 85% by mass or less, and still more preferably 80% by mass or less, based on the total amount of the ink composition. In the present specification, the term “water-based composition” refers to a composition containing 30% by mass or more of water based on the total mass (100% by mass) of the composition.

### 1. 1. 3. (4) Other Components

The ink composition may contain the following components.

### Organic Solvent

The ink composition used in the recording method according to the present embodiment may contain an organic solvent. The organic solvent preferably has water soluble properties. Examples of functions of the organic solvent include improvement of wettability of the ink composition with respect to the fabric and enhancement of moisture retention of the ink composition. The organic solvent can also function as a penetrant.

Examples of the organic solvent can include esters, alkylene glycol ethers, cyclic esters, nitrogen-containing solvents, and polyhydric alcohols. Examples of the nitrogen-containing solvents can include cyclic amides and acyclic amides. Examples of the acyclic amides include alkoxyalkyl amides.

Examples of the esters include glycol monoacetates such as ethylene glycol monomethyl ether acetate, ethylene glycol monoethyl ether acetate, and ethylene glycol monobutyl ether acetate, and glycol diesters such as ethylene glycol diacetate, diethylene glycol diacetate, and propylene glycol diacetate.

The alkylene glycol ethers may be a monoether or diether of an alkylene glycol, and an alkyl ether is preferable. Specific examples thereof include alkylene glycol monoalkyl ethers such as ethylene glycol monomethyl ether, ethylene glycol monoethyl ether, ethylene glycol monoisopropyl ether, ethylene glycol monobutyl ether, and diethylene glycol monomethyl ether; and alkylene glycol dialkyl ethers such as ethylene glycol dimethyl ether, ethylene glycol diethyl ether, ethylene glycol dibutyl ether, and diethylene glycol dimethyl ether, and diethylene glycol diethyl ether.

Examples of the cyclic esters include cyclic esters (lactones) such as β-propiolactone, γ-butyrolactone, δ-valerolactone, ε-caprolactone, and β-butyrolactone; and compounds in which a hydrogen atom of a methylene group adjacent to a carbonyl group thereof is substituted with an alkyl group having 1 to 4 carbon atoms.

Examples of alkoxyalkylamides can include 3-methoxy-N, N-dimethylpropionamide, 3-methoxy-N, N-diethylpropionamide, 3-methoxy-N, N-methylethylpropionamide, 3-ethoxy-N, N-dimethylpropionamide, 3-ethoxy-N, N-diethylpropionamide, 3-ethoxy-N, N-methylethylpropionamide, 3-n-butoxy-N, N-dimethylpropionamide, 3-n-butoxy-N, N-diethylpropionamide, and 3-n-butoxy-N, N-methylethylpropionamide.

The cyclic amides include lactams, and examples thereof include pyrrolidones such as 2-pyrrolidone, 1-methyl-2-pyrrolidone, 1-ethyl-2-pyrrolidone, 1-propyl-2-pyrrolidone, and 1-butyl-2-pyrrolidone.

It is also preferable to use a compound represented by general formula (1) below as the alkoxyalkylamides.

R¹—O—CH₂CH₂—(C═O)—NR²R³ (1)

In formula (1) above, R¹ represents an alkyl group having 1 or more and 4 or less carbon atoms, and R² and R³ each independently represent a methyl group or an ethyl group. The “alkyl group having 1 or more and 4 or less carbon atoms” may be a linear or branched alkyl group, and may be, for example, a methyl group, an ethyl group, an n-propyl group, an iso-propyl group, an n-butyl group, a sec-butyl group, an iso-butyl group, or a tert-butyl group. One kind of the compound represented by formula (1) above may be used singly or two or more kinds thereof may be mixed and used.

Examples of functions of the nitrogen-containing solvent include enhancement of surface drying properties and fixability of the ink composition deposited onto the fabric.

The content of the nitrogen-containing solvent is not particularly limited, but is about 5% by mass or more and 50% by mass or less, and preferably 10% by mass or more and 30% by mass or less based on the total mass of the ink composition. When the content falls within the above ranges, the fixability and surface drying properties of an image (particularly, surface drying properties when the image is recorded in a high-temperature and high-humidity environment) may be further improved.

Examples of the polyhydric alcohols include 1,2-alkanediols (for example, alkanediols such as ethylene glycol, propylene glycol (also known as propane-1,2-diol), 1,2-butanediol, 1,2-pentanediol, 1,2-hexanediol, 1,2-heptanediol, and 1,2-octanediol); and polyhydric alcohols (polyols) (for example, diethylene glycol, dipropylene glycol, 1,3-propanediol, 1,3-butanediol (also known as 1,3-butylene glycol), 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, trimethylolpropane, and glycerin) excluding 1,2-alkanediols.

Examples of the polyhydric alcohols include alkanediols and polyols. The alkanediols are diols of alkanes having 5 or more carbon atoms. The number of carbon atoms in an alkane is preferably 5 to 15, more preferably 6 to 10, and still more preferably 6 to 8. 1,2-Alkanediols are preferable.

The polyols are polyols of alkanes having 4 or less carbon atoms or intermolecular condensation products of polyols of alkanes having 4 or less carbon atoms, in which hydroxy groups of the respective polyols are condensed. The number of carbon atoms in an alkane is preferably 2 to 3. The number of hydroxy groups in the molecule of the polyols is 2 or more, and preferably 5 or less and more preferably 3 or less. When the polyols are the above-described intermolecular condensation products, the number of intermolecular condensation sites is 2 or more, and preferably 4 or less and more preferably 3 or less. One kind of the polyhydric alcohols may be used singly, or two or more kinds thereof may be mixed and used.

The alkanediols and the polyols can function primarily as a penetration solvent and/or a moisturizing solvent. However, the alkanediols tend to have a strong property as a penetration solvent, and the polyols tend to have a strong property as a moisturizing solvent.

When the ink composition includes the organic solvent, one kind of the organic solvent may be used singly, or two or more kinds thereof may be used in combination. The total content of the organic solvent based on the total mass of the ink composition is, for example, 5% by mass or more and 50% by mass or less, preferably 10% by mass or more and 45% by mass or less, more preferably 15% by mass or more and 40% by mass or less, and still more preferably 20% by mass or more and 40% by mass or less. When the content of the organic solvent falls within the above range, the balance between wet-spreading properties and drying properties is further improved, and an image with higher quality is easily formed.

The organic solvent preferably includes a polyhydric alcohol, and more preferably includes a polyhydric alcohol having a standard boiling point of 250° C. or higher. The content of the polyhydric alcohol having a standard boiling point of 250° C. or higher is preferably 1% by mass or more, more preferably 5% by mass or more, still more preferably 10% by mass or more, even more preferably 13% by mass or more, and particularly preferably 15% by mass or more, based on the total amount of the ink composition. The upper limit thereof is not particularly limited, but is preferably 40% by mass or less, more preferably 35% by mass or less, still more preferably 30% by mass or less, even more preferably 25% by mass or less, and particularly preferably 20% by mass or less. When the content of the polyhydric alcohol having a standard boiling point of 250° C. or higher falls within the above ranges, the balance between moisture retention and the drying properties is excellent, and both intermittent printing stability and friction fastness tend to be good.

### Surfactant

The ink composition may contain a surfactant. The surfactant has a function to adjust the surface tension of the ink composition to, for example, adjust wettability with respect to the fabric. Among surfactants, for example, an acetylene glycol-based surfactant, a silicone-based surfactant, and a fluorine-based surfactant can be preferably used.

Although the acetylene glycol-based surfactant is not particularly limited, examples thereof include SURFYNOL 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (which are all product names, manufactured by Air Products and Chemicals, Inc.), OLFINE B, Y, P, A, STG, SPC, E1004, E1010, PD-001, PD-002W, PD-003, PD-004, EXP. 4001, EXP. 4036, EXP. 4051, AF-103, AF-104, AK-02, SK-14, and AE-3 (which are all product names, manufactured by Nissin Chemical Industry Co., Ltd.), and Acetylenol E00, EOOP, E40, and E100 (which are all product names, manufactured by Kawaken Fine Chemicals Co., Ltd.).

Although the silicone-based surfactant is not particularly limited, preferable examples thereof include a polysiloxane-based compound. Although the polysiloxane-based compound is not particularly limited, examples thereof include a polyether-modified organosiloxane. Examples of commercially available products of the polyether-modified organosiloxane include BYK-306, BYK-307, BYK-333, BYK-341, BYK-345, BYK-346, and BYK-348 (which are all product names, manufactured by BYK Japan KK), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (which are all product names, manufactured by Shin-Etsu Chemical Co., Ltd.), and SILFACE SAG002, 005, 503A, and 008 (which are all product names, manufactured by Nissin Chemical Industry Co., Ltd.).

As the fluorine-based surfactant, a fluorine-modified polymer is preferably used, and specific examples thereof include BYK-3440 (manufactured by BYK Japan KK), SURFLON S-241, S-242, and S-243 (which are all product names, manufactured by AGC Seimi Chemical Co., Ltd.), and FTERGENT 215M (manufactured by NEOS COMPANY LIMITED).

When the surfactant is contained in the ink composition, multiple kinds of the surfactant may be contained. When the surfactant is contained in the ink composition, the content of the surfactant in the ink composition may be 0.1% by mass or more and 2% by mass or less, preferably 0.4% by mass or more and 1.5% by mass or less, and more preferably 0.5% by mass or more and 1.0% by mass or less, based on the total mass of the ink composition.

### Wax

The ink composition may contain a wax. Since the wax has a function to impart smoothness to an image formed by the ink composition, peeling or the like of the image formed by the ink composition can be reduced.

As a component constituting the wax, one kind of plant and animal waxes such as carnauba wax, candelilla wax, beeswax, rice wax, and lanolin; petroleum waxes such as paraffin wax, microcrystalline wax, polyethylene wax, oxidized polyethylene wax, and petrolatum; mineral waxes such as montan wax and ozokerite; synthetic waxes such as carbon wax, Hoechst wax, polyolefin wax, and stearic acid amide; natural/synthetic wax emulsions such as an α-olefin/maleic anhydride copolymer; and compounded waxes can be used singly, or multiple kinds thereof can be mixed and used, for example. Among them, polyolefin wax (particularly, polyethylene wax and polypropylene wax) and paraffin wax are preferably used from the viewpoint that the effect of enhancing fixability to a soft packaging film described later is more excellent.

A commercially available product can be directly used as the wax, and examples thereof include NOPCOTE PEM-17 (product name, manufactured by SAN NOPCO LIMITED), CHEMIPEARL W4005 (product name, manufactured by Mitsui Chemicals, Inc.), and AQUACER 515, 539, and 593 (which are all product names, manufactured by BYK Japan KK).

The wax may be supplied in a form of emulsion or suspension. When the wax is used, the content thereof is 0.1% by mass or more and 10% by mass or less, more preferably 0.5% by mass or more and 5% by mass or less, and still more preferably 0.5% by mass or more and 2% by mass or less in terms of solid content based on the total mass of the ink composition. When the content of the wax falls within the above ranges, the function of the wax described above can be favorably exhibited.

### Additives

The ink composition may contain, as additives, urea species, amines, saccharides, and the like. Examples of the urea species include urea, ethylene urea, tetramethyl urea, thiourea, 1,3-dimethyl-2-imidazolidinone, and betaines (trimethylglycine, triethylglycine, tripropylglycine, triisopropylglycine, N, N, N-trimethylalanine, N, N, N-triethylalanine, N, N, N-triisopropylalanine, N, N, N-trimethylmethylalanine, carnitine, acetylcarnitine, and the like).

Examples of the amines include diethanolamine, triethanolamine, and triisopropanolamine. Urea species and amines may function as a pH adjusting agent. Examples of the saccharides include glucose, mannose, fructose, ribose, xylose, arabinose, galactose, aldonic acid, glucitol (sorbit), maltose, cellobiose, lactose, sucrose, trehalose, and maltotriose.

### pH Adjusting Agent

A pH adjusting agent can be added to the ink composition of the present embodiment for the purpose of adjusting pH. Examples of the pH adjusting agent include, but are not particularly limited to, an appropriate combination of an acid, a base, a weak acid, and a weak base. Examples of the acid and base used in such a combination include sulfuric acid, hydrochloric acid, nitric acid, and the like as inorganic acids, lithium hydroxide, sodium hydroxide, potassium hydroxide, potassium dihydrogen phosphate, disodium hydrogen phosphate, potassium carbonate, sodium carbonate, sodium hydrogen carbonate, ammonia, and the like as inorganic bases, and triethanolamine, diethanolamine, monoethanolamine, tripropanolamine, triisopropanolamine, diisopropanolamine, tris(hydroxymethyl)aminomethane (THAM), and the like as organic bases; and adipic acid, citric acid, succinic acid, lactic acid, Good's buffers such as N, N-bis(2-hydroxyethyl)-2-aminoethanesulfonic acid (BES), 4-(2-hydroxyethyl)-1-piperazineethanesulfonic acid (HEPES), morpholinoethanesulfonic acid (MES), carbamoylmethyliminobisacetic acid (ADA), piperazine-1,4-bis(2-ethanesulfonic acid) (PIPES), N-(2-acetamido)-2-aminoethanesulfonic acid (ACES), cholamine chloride, N-tris(hydroxymethyl)methyl-2-aminoethanesulfonic acid (TES), acetamide glycine, tricine, glycinamide, and bicine, a phosphate buffer, a citrate buffer, or a tris buffer, and the like may be used as the organic acid. Among them, it is also preferable that a tertiary amine such as triethanolamine or triisopropanolamine and a carboxy group-containing organic acid such as adipic acid, citric acid, succinic acid, or lactic acid be included as a part or the whole of the pH adjusting agent, because the pH buffering effect can be more stably obtained.

### Urea Species

Urea species may be used as a moisturizing agent for the ink composition. Specific examples of the urea species include urea, ethylene urea, tetramethylurea, thiourea, and 1,3-dimethyl-2-imidazolidinone. In the case of including the urea species, the content thereof can be 1% by mass or more and 10% by mass or less based on the total mass of the ink composition.

### Saccharides

Saccharides may be used for the purpose of suppressing solidification and drying of the ink composition. Specific examples of the saccharides include glucose, mannose, fructose, ribose, xylose, arabinose, galactose, aldonic acid, glucitol (sorbit), maltose, cellobiose, lactose, sucrose, trehalose, and maltotriose.

### Chelating Agent

A chelating agent may be used for the purpose of removing unnecessary ions in the ink composition. Examples of the chelating agent include ethylenediaminetetraacetic acid and salts thereof (dihydrogen disodium salt of ethylenediaminetetraacetic acid or nitrilotriacetate, hexametaphosphate, pyrophosphate, or metaphosphate of ethylenediamine, for example).

### Preservative and Fungicide

A preservative and a fungicide may be used in the ink composition. Examples of the preservative and the fungicide include sodium benzoate, sodium pentachlorophenol, sodium 2-pyridinethiol-1-oxide, sodium sorbate, sodium dehydroacetate, proxel CRL, proxel BDN, proxel GXL, proxel XL-2, proxel IB, and proxel TN (which are all product names, manufactured by Lonza K. K.), and 4-chloro-3-methylphenol (such as Preventol CMK manufactured by Bayer AG).

### Antirust

An antirust may be used in the ink composition. Preferable examples of the antirust include benzotriazole, an acidic sulfite, sodium thiosulfate, antimony thioglycolate, diisopropylammonium nitrite, pentaerythritol tetranitrate, and dicyclohexylammonium nitrite. Among them, benzotriazole is particularly preferable.

### Others

The ink composition used in the recording method according to the present embodiment may further contain components such as a viscosity modifier, an antioxidant, an antifungal agent, an oxygen absorber, and a dissolution aid, if necessary.

### 1. 1. 3. (5) Physical Properties and Production of Ink Composition

From the point that the ink composition is deposited onto the recording medium by an ink jet method, the viscosity of the ink composition at 20° C. is preferably 1.5 mPa·s or more and 15 mPa·s or less, more preferably 1.5 mPa·s or more and 7 mPa·s or less, and still more preferably 1.5 mPa·s or more and 5.5 mPa's or less. When the ink composition is deposited onto the recording medium by an ink jet method, it is easy to efficiently form a predetermined image on the recording medium.

The surface tension of the ink composition at 25° C. is 40 mN/m or less, preferably 38 mN/m or less, and more preferably 35 mN/m or less from the viewpoint of making wet-spreading properties to the recording medium appropriate. The surface tension is preferably 20 mN/m or more and more preferably 25 mN/m or more.

The surface tension can be measured by confirming the surface tension when a platinum plate is wetted with the composition in an environment of 25° C. using an automatic surface tensiometer CBVP-Z (manufactured by Kyowa Interface Science Co., Ltd.).

The ink composition is obtained by mixing the components described above in an appropriate order and removing impurities through filtration or the like as necessary. As a method of mixing the respective components, a method in which materials are sequentially added to a container equipped with a stirring device such as a mechanical stirrer or a magnetic stirrer, and are stirred and mixed is preferably used. As a filtration method, centrifugal filtration, filter filtration, or the like can be performed as necessary.

### 1. 1. 4. Method of Depositing Ink Composition onto Recording Medium

The ink deposition step may be performed by any method according to an ink jet method in which the ink composition is deposited while scanning an ink jet head with respect to the recording medium. In the ink jet method, main scanning in which recording is performed by moving the ink jet head in a direction perpendicular to a transport direction of the recording medium is performed. Although details will be described later, the ink composition and a reaction liquid composition are deposited onto the same scanning region of the recording medium by the same main scanning.

The deposition amount of the ink composition in the ink deposition step is preferably 5.0 (mg/inch²) or more. Furthermore, the deposition amount is preferably 7.0 (mg/inch²) or more, preferably 9.0 (mg/inch²) or more, more preferably 10.0 (mg/inch²) or more, still more preferably 13.0 (mg/inch²) or more, and even more preferably 15.0 (mg/inch²) or more. Consequently, a colored image with better color developability can be obtained.

An upper limit of the deposition amount is preferably 50.0 (mg/inch²) or less, more preferably 40.0 (mg/inch²) or less, and still more preferably 25.0 (mg/inch²) or less.

### 1. 2. First Treatment Liquid Deposition Step

In the first treatment liquid deposition step, a first treatment liquid composition containing resin particles and water is deposited onto the recording medium by an ink jet method. The first treatment liquid deposition step is performed at least on the entire image region.

### 1. 2. 1. First Treatment Liquid Composition

The first treatment liquid composition contains resin particles (resin dispersion) and water.

### 1. 2. 1. (1) Resin Particles

Since the resin particles are the same as the resin particles contained in the ink composition described above, the description thereof will be omitted. The resin particles contained in the first treatment liquid composition may be the same as or different from the resin particles contained in the ink composition. When the resin particles contained in the first treatment liquid composition are the same as the resin particles contained in the ink composition, an image distortion may be less likely to occur.

The content of the resin particles in the first treatment liquid composition is preferably 80% by mass or more, more preferably 85% by mass or more, and still more preferably 90% by mass or more based on the total amount of nonvolatile components in the first treatment liquid composition. When the content of the resin particles in the first treatment liquid composition falls within these ranges, a recorded matter with even better friction fastness is obtained.

### 1. 2. 1. (2) Other Components

The first treatment liquid composition may contain other components. The other components are the same as those described in “1. 1. 3. (4) Other components,” and the description thereof is omitted.

In the first treatment liquid composition, the content of the coloring material is preferably 0.1% by mass or less based on the total amount of the first treatment liquid composition. That is, it is preferable that the first treatment liquid composition be not intended for coloring.

### 1. 2. 1. (3) Production and Physical Properties

From the point that the first treatment liquid composition is deposited onto fabric or the like by an ink jet method, the viscosity of the first treatment liquid composition at 20° C. is preferably 1.5 mPa's or more and 15 mPa·s or less, more preferably 1.5 mPa·s or more and 7 mPa·s or less, and still more preferably 1.5 mPa's or more and 5.5 mPa·s or less.

The surface tension of the first treatment liquid composition at 25° C. is 40 mN/m or less, preferably 38 mN/m or less, more preferably 35 mN/m or less, and still more preferably 30 mN/m or less from the viewpoint of making wet-spreading properties to the fabric appropriate. The surface tension is preferably 25 mN/m or more and more preferably 28 mN/m or more. When the surface tension of the first treatment liquid composition is high, the first treatment liquid composition is less likely to be scattered when the composition is discharged from a nozzle, mist is less likely to be generated during discharge, and discharge stability can be further improved.

The first treatment liquid composition is obtained by mixing the components described above in an appropriate order and removing impurities through filtration or the like as necessary. As a method of mixing the respective components, a method in which materials are sequentially added to a container equipped with a stirring device such as a mechanical stirrer or a magnetic stirrer, and are stirred and mixed is preferably used. As a filtration method, centrifugal filtration, filter filtration, or the like can be performed as necessary.

### 1. 2. 2. Deposition Form

The first treatment liquid deposition step is performed by an ink jet method. In the recording method according to the present embodiment, the deposition amount of the first treatment liquid composition in the first treatment liquid deposition step is 12 mL/m² or more. The deposition amount of the first treatment liquid composition in the first treatment liquid deposition step is more preferably 12.5 mL/m² or more and further preferably 15 mL/m² or more. When the first treatment liquid composition is deposited onto the image region at a deposition amount of 12 mL/m² or more, a difference in shrinkage between the image region and the deposition region of the first treatment liquid composition becomes small, and an image distortion can be suppressed.

### 1. 3. Second Treatment Liquid Deposition Step

In the second treatment liquid deposition step, a second treatment liquid composition containing a softening agent is deposited onto the recording medium by an ink jet method. The second treatment liquid deposition step is performed at least on the entire image region.

### 1. 3. 1. Second Treatment Liquid Composition

The second treatment liquid composition contains a softening agent.

### 1. 3. 1. (1) Softening Agent

The softening agent includes particles containing an organopolysiloxane, a fatty acid ester, a dialkyldimethylammonium salt, an imidazoline-type surfactant, and an amphoteric surfactant.

### Particles Containing Organopolysiloxane

The particles containing an organopolysiloxane are not particularly limited as long as the particles contain an organopolysiloxane, and may be, for example, organopolysiloxane particles or particles in a state in which an organopolysiloxane is dispersed by an emulsifier or the like. The properties of the organopolysiloxane in such particles may be solid or liquid. For example, when an oily organopolysiloxane is dispersed in a particulate form in water with an emulsifier, the dispersed particles correspond to the particles containing an organopolysiloxane.

The organopolysiloxane is a generic name of an organosilicon compound having a siloxane bond “—Si(R¹R²)—O—” as a skeleton to which a methyl group, a phenyl group, a vinyl group, an amino group, or the like is bonded as the organic group R¹ or R². Organopolysiloxanes exhibit oily, rubbery, and resinous properties depending on the chemical composition and molecular weight, and may be referred to as silicone oil, silicone rubber, or silicone resin (silicon resin), respectively.

The organopolysiloxane used in the second treatment liquid composition of the present embodiment is more preferably an oily compound. When the organopolysiloxane is an oily compound, it is easy to stably disperse the organopolysiloxane in a particulate form in an aqueous matrix by an emulsification treatment described later.

The molecular structure of the organopolysiloxane is not particularly limited, and examples thereof include a linear structure, a branched structure, a cyclic structure, a lattice structure, and a cage structure. When the molecular structure of the organopolysiloxane is an acyclic structure, one or two or more groups selected from a hydrocarbon group which may have a substituent, an alkoxy group, a hydroxy group, a hydrogen atom, and a halogen atom are usually bonded to a Si atom at a terminal of the molecule.

The organopolysiloxane is not particularly limited, and examples thereof include dimethyl silicone, alkyl-modified silicone, amino-modified silicone, epoxy-modified silicone, cyclic silicone, and methylphenyl silicone. One kind thereof may be used singly, or two or more kinds thereof may be mixed and used.

An organopolysiloxane commercially available as silicone oil may be used. Examples thereof include dimethyl silicone oil, methylphenyl silicone oil, methyl hydrogen silicone oil, polyether-modified silicone oil, aralkyl-modified silicone oil, fluoroalkyl-modified silicone oil, long-chain alkyl-modified silicone oil, higher fatty acid ester-modified silicone oil, higher fatty acid amide-modified silicone oil, polyether/long-chain alkyl/aralkyl-modified silicone oil, long-chain alkyl/aralkyl-modified silicone oil, phenyl-modified silicone oil, and polyether/methoxy-modified silicone oil.

Among the examples of the organopolysiloxane shown above, nonionic silicone is more preferable. Among the examples of the organopolysiloxane shown above, unmodified silicone is more preferable. Such an organopolysiloxane is chemically more stable and is less likely to cause yellowing or the like of a formed image.

Furthermore, the organopolysiloxane is more preferably one or more kinds selected from dimethyl silicone, methylphenyl silicone, and methylhydrogen silicone.

The softening agent is more preferably a dimethyl silicone-based softening agent. By using the dimethyl silicone-based softening agent, a recorded matter with better texture can be obtained.

Commercially available products of silicone oil include dimethyl silicone (manufactured by Shin-Etsu Chemical Co., Ltd.: KF-96 series), methyl hydrogen-type polysiloxane (manufactured by Shin-Etsu Chemical Co., Ltd.: KF-99 series, KF-9901, etc.), methylphenyl silicone (manufactured by Shin-Etsu Chemical Co., Ltd.: KF-50 series, etc.), amino-modified silicone (Shin-Etsu Silicone manufactured by Shin-Etsu Chemical Co., Ltd.: KF-868, etc.), a silicone branched-type silicone treatment agent (manufactured by Shin-Etsu Chemical Co., Ltd.: KF-9908, KF-9909, etc.), HISOFTER K-45 (manufactured by Meisei Chemical Works, Ltd.), and Polyester-based softening agent EX-200A manufactured by TAKAMATSU OIL & FAT CO., LTD.

The viscosity at 25° C. of the silicone is not particularly limited but is preferably 1000 mPa·s or less and preferably 50 mPa·s or more, more preferably 500 mPa·s or more and 900 mPa·s or less, and still more preferably 600 mPa·s or more and 700 mPa·s or less. The base oil viscosity when the silicone is emulsified and dispersed is not particularly limited, but the upper limit thereof is preferably 1,000,000 mm²/s or less and more preferably 100,000 mm²/s or less, and the lower limit thereof is preferably 10 mm²/s or more and more preferably 100 mm²/s or more. Note that the base oil viscosity represents the viscosity of base oil, and is a numerical value obtained by measuring the magnitude of the internal resistance of the base oil. The larger the numerical value of the base oil viscosity, the higher the viscosity, and the smaller the numerical value of the base oil viscosity, the lower the viscosity of the base oil.

The organopolysiloxane may be emulsified into particles using various surfactants as an emulsifier and blended. As the emulsifier in this case, a nonionic surfactant, an anionic surfactant, a cationic surfactant, an amphoteric surfactant, a phospholipid, or the like can be used, for example.

Examples of the nonionic surfactant can include a glycerin fatty acid ester, a polyglycerin fatty acid ester, a propylene glycol fatty acid ester, a sorbitan fatty acid ester, and a fatty acid ester of sorbitol, and an alkylene glycol adduct thereof, a polyalkylene glycol fatty acid ester, a sucrose fatty acid ester, Polysorbate 20, Polysorbate 60, Polysorbate 80, and a polyoxyalkylene alkyl ether, and a polyoxyethylene alkylphenyl ether.

A nonionic surfactant such as a polyoxyethylene glycerin fatty acid ester, a polyglycerin fatty acid ester, a sorbitan fatty acid ester, a polyoxyethylene sorbitan fatty acid ester, a polyoxyethylene sorbit fatty acid ester, a polyethylene glycol fatty acid ester, polyoxyethylene castor oil, polyoxyethylene hydrogenated castor oil, polyoxyethylene phytosterol, polyoxyethylene polyoxypropylene alkyl ether, polyoxyethylene lanolin, polyoxyethylene lanolin alcohol, a polyoxyethylene beeswax derivative, a polyoxyethylene alkylamine, a polyoxyethylene fatty acid amide, a polyoxyethylene alkylphenyl formaldehyde condensate, or a polyoxyethylene alkyl ether phosphate (salt) is also preferably used as the nonionic surfactant, for example.

Examples of the anionic surfactant include an alkyl sulfate salt, a polyoxyethylene alkyl sulfate salt, an alkylbenzene sulfonate, and an α-olefin sulfonate. Examples of the cationic surfactant include alkyltrimethylammonium chloride, dialkyldimethylammonium chloride, and benzalkonium chloride. Examples of the amphoteric surfactant include alkyldimethylaminoacetate betaine and alkylamidodimethylaminoacetate betaine. Further, a naturally derived surfactant may also be used, and examples thereof include lecithin, lanolin, cholesterol, and saponin.

The blending amount of the emulsifier in emulsifying the organopolysiloxane is preferably less than 20% by mass, more preferably 15% by mass or less, and particularly preferably 10% by mass or less of the total amount of the emulsified composition.

The average particle diameter of the emulsified particulate organopolysiloxane particles is 2 μm or less and preferably 1 μm or less, and more preferably falls within the range of 0.05 to 0.5 μm.

### Fatty Acid Ester

Examples of the fatty acid ester include polyoxyethylene monocaprate, polyoxyethylene monocaprylate, polyoxyethylene monolaurate, polyoxyethylene monomyristate, polyoxyethylene monopalmitate, polyoxyethylene monostearate, polyoxyethylene monooleate, polyoxyethylene monoisostearate, polyoxyethylene monobehenate, polyoxyethylene dicaprate, polyoxyethylene dicaprylate, polyoxyethylene dilaurate, polyoxyethylene dimyristate, polyoxyethylene dipalmitate, polyoxyethylene distearate, polyoxyethylene dioleate, polyoxyethylene diisostearate, and polyoxyethylene dibehenate.

### Dialkyldimethylammonium Salt

Examples of the dialkyldimethylammonium salt include dioleoyloxytrimethylammonium propane chloride (DOTAP), dioctadecenyltrimethylammonium propane chloride (DOTMA), didecyldimethylammonium chloride, didecyldimethylammonium bromide, dicocoyldimethylammonium chloride, dicocoyldimethylammonium bromide, dilauryldimethylammonium chloride, dicetyldimethylammonium chloride, dicetyldimethylammonium bromide, distearyldimethylammonium chloride, distearyldimethylammonium bromide, dioleyldimethylammonium chloride, dibehenyldimethylammonium chloride, dibehenyldimethylammonium bromide, dialkyldimethylammonium chloride, dialkyldimethylammonium bromide, dicocoylethylhydroxyethylmonium methosulfate, dipalmitoylethylhydroxyethylmonium methosulfate, and distearoylethylhydroxyethylmonium methosulfate.

### Imidazoline-Type Surfactant

Examples of the imidazoline-type surfactant include 1-hydroxyethyl-2-laurylimidazoline, 1-aminoethyl-2-laurylimidazoline, 1-hydroxyethyl-2-myristylimidazoline, 1-aminoethyl-2-myristylimidazoline, 1-hydroxyethyl-2-palmitylimidazoline, 1-aminoethyl-2-palmitylimidazoline, 1-hydroxyethyl-2-oleylimidazoline, 1-aminoethyl-2-oleylimidazoline, 1-hydroxyethyl-2-stearylimidazoline, 1-aminoethyl-2-stearylimidazoline, 2-alkyl-N-carboxymethylimidazolinium betaine, 2-alkyl-N-carboxyethylimidazolinium betaine, and 2-alkyl-N-carboxymethyl-N-hydroxyethylimidazolinium betaine.

### Amphoteric Surfactant

Examples of the amphoteric surfactant include an alkylcarboxybetaine, an alkylsulfobetaine, an alkylhydroxysulfobetaine, an alkylamidobetaine, lauryldimethylamine oxide, and lauric amidopropyldimethylamine oxide.

The softening agent is preferably at least one selected from the particles containing the organopolysiloxane, the fatty acid ester, the dialkyldimethylammonium salt, the imidazoline-type surfactant, and the amphoteric surfactant exemplified above. Consequently, wet friction fastness of an image on a recorded matter formed by the recording method is further improved.

The softening agent is more preferably at least one selected from the particles containing the organopolysiloxane. Since a water-repellent effect can be imparted to fibers of the recording medium by the second treatment liquid composition thereby, the wet friction fastness of an image on a recorded matter can be further improved.

When the particles containing the organopolysiloxane are selected as the softening agent, the organopolysiloxane is more preferably nonionic. Consequently, yellowing of a recorded matter can be further suppressed.

The content of the softening agent in the second treatment liquid composition is preferably 60% by mass or more, more preferably 65% by mass or more, and still more preferably 70% by mass or more based on the total amount of nonvolatile components in the second treatment liquid composition. When the content of the softening agent in the second treatment liquid composition is within these ranges, a recorded matter with better texture is obtained.

The content of the softening agent is more preferably 8% by mass or more and 15% by mass or less, still more preferably 9% by mass or more and 14% by mass or less, and particularly preferably 12% by mass or more and 14% by mass or less based on the total amount of the second treatment liquid composition. When the content of the softening agent in the second treatment liquid composition is within these ranges, a recorded matter with better texture is obtained.

### 1. 3. 1. (2) Other Components

The second treatment liquid composition may include other components. The other components are the same as those described in “1. 1. 3. (4) Other components,” and the description thereof is omitted.

In the second treatment liquid composition, the content of the coloring material is preferably 0.1% by mass or less based on the total amount of the second treatment liquid composition. That is, it is preferable that the second treatment liquid composition be not intended for coloring.

### 1. 3. 1. (3) Production and Physical Properties

From the point that the second treatment liquid composition is deposited onto fabric or the like by an ink jet method, the viscosity of the second treatment liquid composition at 20° C. is preferably 1.5 mPa·s or more and 15 mPa·s or less, more preferably 1.5 mPa·s or more and 7 mPa·s or less, and still more preferably 1.5 mPa's or more and 5.5 mPa·s or less.

The surface tension of the second treatment liquid composition at 25° C. is 40 mN/m or less, preferably 38 mN/m or less, more preferably 35 mN/m or less, and still more preferably 30 mN/m or less from the viewpoint of making wet-spreading properties to the fabric appropriate. The surface tension is preferably 25 mN/m or more and more preferably 28 mN/m or more. When the surface tension of the second treatment liquid composition is high, the second treatment liquid composition is less likely to be scattered when the composition is discharged from a nozzle, mist is less likely to be generated during discharge, and discharge stability can be further improved.

The second treatment liquid composition is obtained by mixing the components described above in an appropriate order and removing impurities through filtration or the like as necessary. As a method of mixing the respective components, a method in which materials are sequentially added to a container equipped with a stirring device such as a mechanical stirrer or a magnetic stirrer, and are stirred and mixed is preferably used. As a filtration method, centrifugal filtration, filter filtration, or the like can be performed as necessary.

### 1. 3. 2. Deposition Form

The second treatment liquid deposition step is performed by an ink jet method. The deposition amount of the second treatment liquid composition in the second treatment liquid deposition step is preferably 2 g/m² or more and 50 g/m² or less, more preferably 5 g/m² or more and 25 g/m² or less, and still more preferably 10 g/m² or more and 15 g/m² or less.

### 1. 4. Relationship of Contents of Resin Particles in Each Composition

When the content of the resin particles in the ink composition described above is 4% by mass or more and 8% by mass or less based on the total amount of the ink composition, and the content of the resin particles in the first treatment liquid composition is 10% by mass or more and 15% by mass or less based on the total amount of the first treatment liquid composition, the difference in shrinkage between the image region and the deposition region of the first treatment liquid composition can be easily reduced, and an image distortion can be further easily suppressed.

### 1. 5. Deposition Amount of Each Treatment Liquid

In the image region, the difference in the sum of the deposition amount of the ink composition and the deposition amount of the first treatment liquid composition per unit area between the region where the sum is maximum and the region where the sum is minimum is preferably 20 mL/m² or less, more preferably 17 mL/m² or less, still more preferably 13 mL/m² or less, and particularly preferably 10 mL/m² or less. Consequently, the sum of the deposition amount of the ink composition and the deposition amount of the first treatment liquid composition is substantially uniform in the image region, and an image distortion can thus be further suppressed.

The deposition amount of the second treatment liquid composition is preferably equal to or greater than one half of the deposition amount of the first treatment liquid composition, more preferably equal to or greater than the deposition amount of the first treatment liquid composition, and still more preferably equal to or greater than 1.3 times the deposition amount the first treatment liquid composition. Consequently, a recorded matter with better texture is obtained.

### 1. 6. Other Steps

The recording method of the present embodiment may further include a reaction liquid deposition step of depositing, onto the recording medium, a reaction liquid composition containing an aggregating agent that aggregates the components in the ink composition.

### 1. 6. 1. Reaction Liquid Deposition Step

When the reaction liquid deposition step is included, the reaction liquid composition containing the aggregating agent that aggregates the components in the ink composition is deposited onto the recording medium in this step. Consequently, an image with more excellent color developability can be formed.

The reaction liquid composition contains the aggregating agent that aggregates the components in the ink composition. The aggregating agent has an action of reacting with components such as the pigment included in the ink composition and the resin particles included in the ink composition and the first treatment liquid composition to aggregate the pigment and the resin particles. Such aggregation can, for example, facilitate color development of the pigment, enhance fixability of the resin particles, and/or increase the viscosity of ink, for example.

### 1. 6. 1. (1) Aggregating Agent

Although the aggregating agent is not particularly limited, examples thereof include a metal salt, an inorganic acid, an organic acid, and a cationic compound, and a cationic resin (cationic polymer), a cationic surfactant, or the like can be used as the cationic compound. Among them, a polyvalent metal salt is preferable as the metal salt, and a cationic resin is preferable as the cationic compound. Therefore, the aggregating agent is preferably selected from a polyvalent metal salt, an organic acid, and a cationic polymer, from the point of providing more excellent color developability, image quality, abrasion resistance, gloss, and the like.

The metal salt is preferably a polyvalent metal salt, but a metal salt other than polyvalent metal salts can also be used. Among these aggregating agents, at least one selected from a metal salt and an organic acid is preferably used from the point of excellent reactivity with components included in ink. Among the cationic compounds, a cationic resin is preferably used from the point of being easily dissolved in treatment liquids. Multiple aggregating agents may be used in combination.

The polyvalent metal salt is a compound composed of a divalent or higher-valent metal ion and an anion. Examples of the divalent or higher-valent metal ion include ions of calcium, magnesium, copper, nickel, zinc, barium, aluminum, titanium, strontium, chromium, cobalt, iron, and the like. Among these metal ions constituting the polyvalent metal salt, at least one of calcium ions and magnesium ions is preferable from the point of excellent aggregability of the components of ink.

The anion constituting the polyvalent metal salt is an inorganic ion or an organic ion. That is, the polyvalent metal salt in the present disclosure is composed of an inorganic ion or an organic ion and a polyvalent metal. Examples of such an inorganic ion include chlorine ions, bromine ions, iodine ions, nitrate ions, sulfate ions, and hydroxide ions. Examples of the organic ion include organic acid ions, and include carboxylic acid ions.

The polyvalent metal compound is preferably an ionic polyvalent metal salt. In particular, when the polyvalent metal salt is a magnesium salt or a calcium salt, stability of the treatment liquid becomes better. The counter ion for the polyvalent metal may be either an inorganic acid ion or an organic acid ion.

Specific examples of the polyvalent metal salt described above include calcium carbonate such as heavy calcium carbonate and light calcium carbonate, calcium nitrate, calcium chloride, calcium sulfate, magnesium sulfate, calcium hydroxide, magnesium chloride, magnesium carbonate, barium sulfate, barium chloride, zinc carbonate, zinc sulfide, aluminum silicate, calcium silicate, magnesium silicate, copper nitrate, calcium formate, calcium acetate, magnesium acetate, and aluminum acetate. One kind of these polyvalent metal salts may be used singly, or two or more kinds thereof may be used in combination. Among them, at least one of calcium formate, magnesium sulfate, calcium nitrate, and calcium chloride is preferable, and calcium formate and calcium nitrate are more preferable, because sufficient solubility in water is secured, and residues left by the treatment liquid are reduced (traces are made inconspicuous). These metal salts may have water of hydration in a raw material form.

Examples of the metal salt other than polyvalent metal salts include monovalent metal salts such as a sodium salt and a potassium salt, and include sodium sulfate and potassium sulfate.

Preferable examples of the organic acid include poly(meth)acrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidone carboxylic acid, pyrone carboxylic acid, pyrrole carboxylic acid, furan carboxylic acid, pyridine carboxylic acid, coumaric acid, thiophene carboxylic acid, nicotinic acid, derivatives of these compounds, and salts thereof. One kind of the organic acid may be used singly, or two or more kinds thereof may be used in combination. Salts of organic acids that are metal salts are included in the metal salts described above.

Examples of the inorganic acid include sulfuric acid, hydrochloric acid, nitric acid, and phosphoric acid. One kind of the inorganic acid may be used singly, or two or more kinds thereof may be used in combination.

Examples of the cationic resin (cationic polymer) include a cationic acrylic resin, a cationic urethane-based resin, a cationic olefin-based resin, a cationic amine-based resin, and a cationic surfactant. The cationic polymer is preferably water soluble.

As the cationic acrylic resin, a commercially available product can be used, and examples thereof include SUPERFLEX (registered trademark) 620 and 650 manufactured by DKS Co. Ltd., Parasurf UP-22 manufactured by OHARA PARAGIUM CHEMICAL CO., LTD., PERMARIN (registered trademark) UC-20 manufactured by Sanyo Chemical Industries, Ltd., ARROWBASE (registered trademark) CB-1200 and CD-1200 manufactured by UNITIKA LTD., VINYBLAN (registered trademark) 2687 manufactured by Nissin Chemical Industry Co., Ltd., and Mowinyl 7820 manufactured by Japan Coating Resin Corporation.

As the cationic urethane-based resin, a commercially available product can be used, and HYDRAN CP-7010, CP-7020, CP-7030, CP-7040, CP-7050, CP-7060, or CP-7610 (product names, manufactured by DIC Corporation), SUPERFLEX 500M, 600, 610, 620, 630, 640, or 650 (product names, manufactured by DKS Co. Ltd.), urethane emulsion WBR-2120C or WBR-2122C (trade names, manufactured by Taisei Fine Chemical Co., Ltd.), or the like can be used, for example.

The cationic olefin resin has an olefin such as ethylene or propylene as the structural skeleton thereof, and a known resin can be appropriately selected and used. The cationic olefin resin may be in an emulsion state in which the cationic olefin resin is dispersed in a solvent including water, an organic solvent, or the like. As the cationic olefin resin, a commercially available product can be used, and examples thereof include ARROWBASE CB-1200 and CD-1200 (product names manufactured by UNITIKA LTD.).

The cationic amine-based resin (cationic polymer) may be any resin as long as it has an amino group in the structure thereof, and a known resin can be appropriately selected and used. Examples thereof include a polyamine resin, a polyamide resin, and a polyallylamine resin. The polyamine resin is a resin having an amino group in the main skeleton of the resin. The polyamide resin is a resin having an amide group in the main skeleton of the resin. The polyallylamine resin is a resin having a structure derived from an allyl group in the main skeleton of the resin.

Examples of the cationic polyamine resin include unisense KHE103L (hexamethylenediamine/epichlorohydrin resin, pH of 1% aqueous solution: about 5.0, viscosity: 20 to 50 (mPa·s), an aqueous solution with a solid content concentration of 50% by mass) and unisense KHE104L (dimethylamine/epichlorohydrin resin, pH of 18 aqueous solution: about 7.0, viscosity: 1 to 10 (mPa·s), an aqueous solution with a solid content concentration of 20% by mass) manufactured by SENKA CORPORATION. Specific examples of commercially available cationic polyamine resins include FL-14 (manufactured by SNF Holding Company), ARAFIX 100, 251S, 255, and 255LOX (manufactured by ARAKAWA CHEMICAL INDUSTRIES, LTD.), DK-6810, 6853, and 6885; WS-4010, 4011, 4020, 4024, 4027, and 4030 (manufactured by SEIKO PMC CORPORATION), PAPYOGEN P-105 (manufactured by SENKA CORPORATION), Sumirez Resin 650 (30), 675A, 6615, and SLX-1 (manufactured by Taoka Chemical Co., Ltd.), Catiomaster (registered trademark) PD-1, 7, 30, A, PDT-2, PE-10, PE-30, DT-EH, EPA-SK01, and TMHMDA-E (manufactured by Yokkaichi Chemical Company Limited), and JETFIX 36N, 38A, and 5052 (manufactured by Satoda Chemical Industrial Co., Ltd.).

The polyamine resin also includes a polyallylamine resin. Examples of the polyallylamine resin include polyallylamine hydrochloride, polyallylamine amide sulfate, an allylamine hydrochloride-diallylamine hydrochloride copolymer, an allylamine acetate-diallylamine acetate copolymer, an allylamine acetate-diallylamine acetate copolymer, an allylamine hydrochloride-dimethylallylamine hydrochloride copolymer, an allylamine-dimethylallylamine copolymer, polydiallylamine hydrochloride, polymethyldiallylamine hydrochloride, polymethyldiallylamine amide sulfate, polymethyldiallylamine acetate, polydiallyldimethylammonium chloride, a diallylamine acetate-sulfur dioxide copolymer, a diallylmethylethylammoniumethylsulfate-sulfur dioxide copolymer, a methyldiallylamine hydrochloride-sulfur dioxide copolymer, a diallyldimethylammonium chloride-sulfur dioxide copolymer, and a diallyldimethylammonium chloride-acrylamide copolymer.

Examples of the cationic surfactant include primary, secondary, and tertiary amine salt compounds, alkylamine salts, dialkylamine salts, aliphatic amine salts, benzalkonium salts, quaternary ammonium salts, quaternary alkylammonium salts, alkylpyridinium salts, sulfonium salts, phosphonium salts, onium salts, and imidazolinium salts.

A plurality of kinds of these aggregating agents may be used. Among these aggregating agents, when the aggregating agent is selected from the polyvalent metal salt, the organic acid, and the cationic polymer, the aggregating action of the pigment and the resin particles is better, an image with higher image quality (especially, good color developability) can thus be formed.

The total content of the aggregating agent in the reaction liquid composition is not limited, but is, for example, 0.1% by mass or more and 15% by mass or less, preferably 1% by mass or more and 10% by mass or less, and more preferably 2% by mass or more and 10% by mass or less based on the total mass of the reaction liquid composition.

### 1. 6. 1. (2) Other Components

The reaction liquid composition may include water, a moisturizing agent, a polyhydric alcohol, an additional solvent, a surfactant, and an additive. Among them, water, the moisturizing agent, the additional solvent, the surfactant, and the additive are the same as those of the ink composition described above, and thus description thereof will be omitted.

In the reaction liquid composition, the content of the coloring material is preferably 0.1% by mass or less based on the total amount of the reaction liquid composition. That is, it is preferable that the reaction liquid composition be not intended for coloring.

### 1. 6. 1. (3) Physical Properties and Production of Reaction Liquid Composition

From the point that the reaction liquid composition is deposited onto the recording medium by an ink jet method, the viscosity of the reaction liquid composition at 20° C. is preferably 1.5 mPa's or more and 15 mPa·s or less, more preferably 1.5 mPa·s or more and 7 mPa·s or less, and still more preferably 1.5 mPa·s or more and 5.5 mPa·s or less. When the reaction liquid composition is deposited onto the recording medium by an ink jet method, it is easy to efficiently form a predetermined image on the recording medium.

The surface tension of the reaction liquid composition at 25° C. is 40 mN/m or less, preferably 38 mN/m or less, and more preferably 35 mN/m or less from the viewpoint of making wet-spreading properties to the recording medium appropriate. The surface tension is preferably 20 mN/m or more and more preferably 25 mN/m or more.

The surface tension can be measured by confirming the surface tension when a platinum plate is wetted with the composition in an environment of 25° C. using an automatic surface tensiometer CBVP-Z (manufactured by Kyowa Interface Science Co., Ltd.).

The reaction liquid composition is obtained by mixing the components described above in an appropriate order and removing impurities through filtration or the like as necessary. As a method of mixing the respective components, a method in which materials are sequentially added to a container equipped with a stirring device such as a mechanical stirrer or a magnetic stirrer, and are stirred and mixed is preferably used. As a filtration method, centrifugal filtration, filter filtration, or the like can be performed as necessary.

### 1. 6. 1. (4) Method of Depositing Reaction Liquid Composition onto Fabric

The reaction liquid deposition step may be performed by any method according to an ink jet method in which the reaction liquid composition is deposited while scanning an ink jet head with respect to the recording medium. In the ink jet method, main scanning in which recording is performed by moving the ink jet head in a direction perpendicular to a transport direction of the recording medium is performed. While details will be described later, the ink composition and the reaction liquid composition are deposited onto the same scanning region of the fabric by the same main scanning.

The reaction liquid deposition step is preferably performed such that the amount of the polyvalent metal salt in the reaction liquid composition to be deposited onto the recording medium is 0.3 (mg/inch²) or more. The amount of the polyvalent metal salt to be deposited onto the recording medium in the reaction liquid deposition step is more preferably 0.5 (mg/inch²) or more and further preferably 0.9 (mg/inch²) or more. With such a deposition amount, even when the ink composition and the reaction liquid composition are deposited onto the same scanning region of the recording medium by the same main scanning, the components of the ink composition and the other compositions can be favorably aggregated, and the color developability can be improved.

Meanwhile, the deposition amount of the polyvalent metal salt is preferably 1.7 (mg/inch²) or less, more preferably 1.5 (mg/inch²) or less, and still more preferably 1.0 (mg/inch²) or less. The color developability of an image can be further improved thereby.

The upper limit is preferably 25.0 (mg/inch²) or less, more preferably 18.0 (mg/inch²) or less, and still more preferably 15.0 (mg/inch²) or less.

In the recording method of the present embodiment, the deposition amount of the reaction liquid composition described above is a decomposition amount in a recording region where the reaction liquid composition and the ink composition are deposited in an overlapping manner. The maximum deposition amount of the reaction liquid composition in the recording region may be set to fall within the above ranges, which is preferable.

### 1. 6. 2. Drying Step

The recording method of the present embodiment may further include a step of heating and drying the recording medium. In the case where this step is included, an image distortion may be more likely to occur, but the effect of reducing a distortion provided by the recording method of the present embodiment is more significantly exhibited.

The drying step can be performed by a drying unit using a drying mechanism. Examples of the drying unit using a drying mechanism include a unit (air blowing type) that blows air at room temperature or blows warm air to the recording medium, a unit (radiation type) that irradiates the recording medium with radiation (infrared rays or the like) generating heat, a member (conductive type) that contacts the recording medium and transfers heat to the fabric, and a combination of two or more of these units. In the case where the drying step is included, the drying step is preferably performed by a drying mechanism that heats the recording medium. A case where the drying mechanism that heats the recording medium is used as the drying mechanism is particularly referred to as a heating step.

The surface temperature of the recording medium at the time of deposition of each composition is preferably 45° C. or lower and more preferably 20° C. or higher and 45° C. or lower. In addition, the surface temperature is preferably 27.0° C. or higher and 40° C. or lower and more preferably 28° C. or higher and 30° C. or lower. The temperature is the surface temperature of the portion of the recording surface of the recording medium onto which a liquid is deposited in the deposition steps, and is the highest temperature of the recording region in the deposition steps. The surface temperature within the above ranges is more preferable in terms of image quality, abrasion resistance, and reduction of clogging.

When the recording medium is fabric, although the heating method is not particularly limited, examples thereof include a heat pressing method, an ordinary pressure steam method, a high pressure steam method, and a Thermofix method. Although the heat source for heating is not particularly limited, an infrared lamp or the like can be used, for example. The heating temperature is preferably a temperature at which the resin particles in ink are fused and a medium such as moisture is volatilized. For example, the temperature is preferably 120° C. or higher and 200° C. or lower and more preferably 150° C. or higher and 160° C. or lower. Here, the heating temperature in the heating step refers to the surface temperature of an image or the like formed on fabric. The heating time is not particularly limited, but is 30 seconds or longer and 20 minutes or shorter, for example.

### 1. 7. Operation and Effect

According to the recording method of the present embodiment, when the resin particles are included in the ink composition, a recorded matter with good friction fastness is obtained. When 12 mL/m² or more of the first treatment liquid composition is deposited onto the image region, the difference in shrinkage between the image region and the deposition region of the first treatment liquid composition becomes small, and an image distortion can be suppressed. Further, when the second treatment liquid composition is further deposited, the texture of the recorded matter can also be improved.

### 2. Example of Recording Device

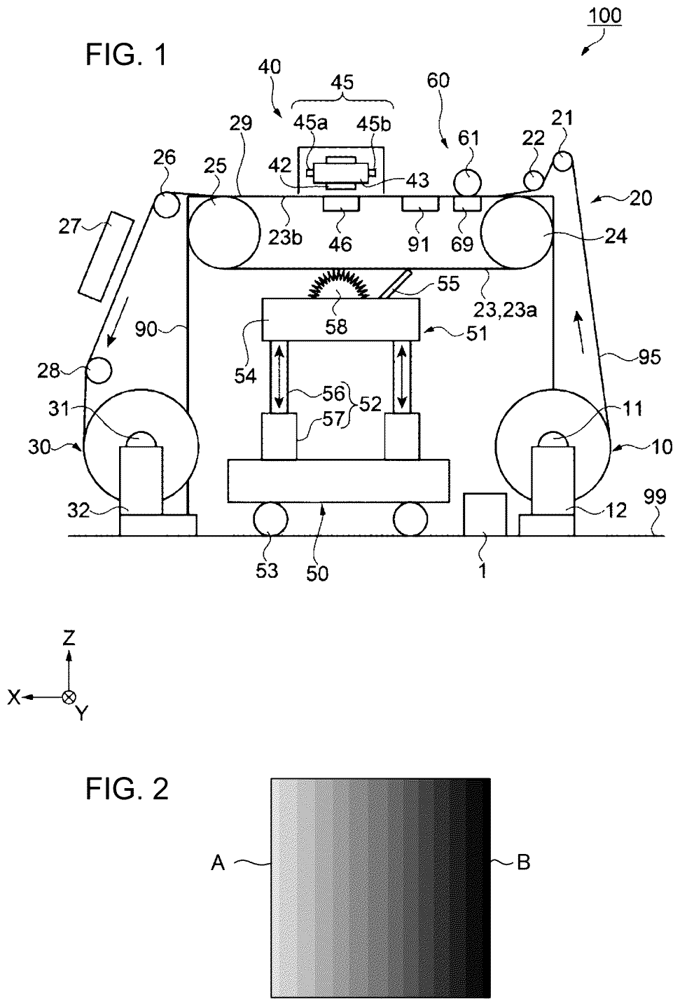

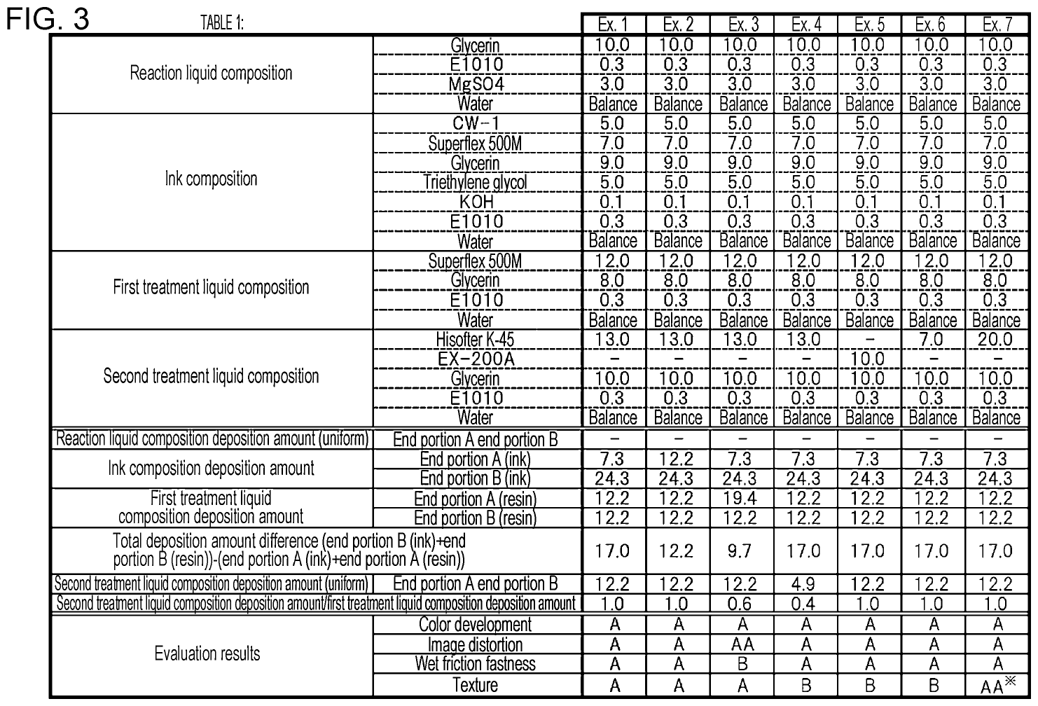

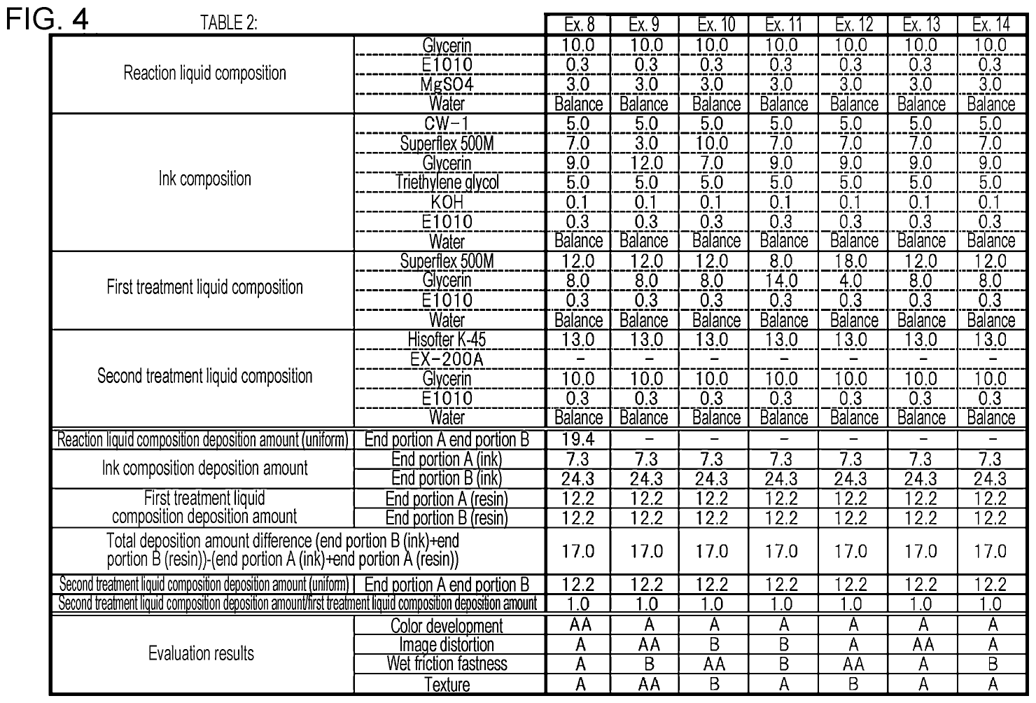

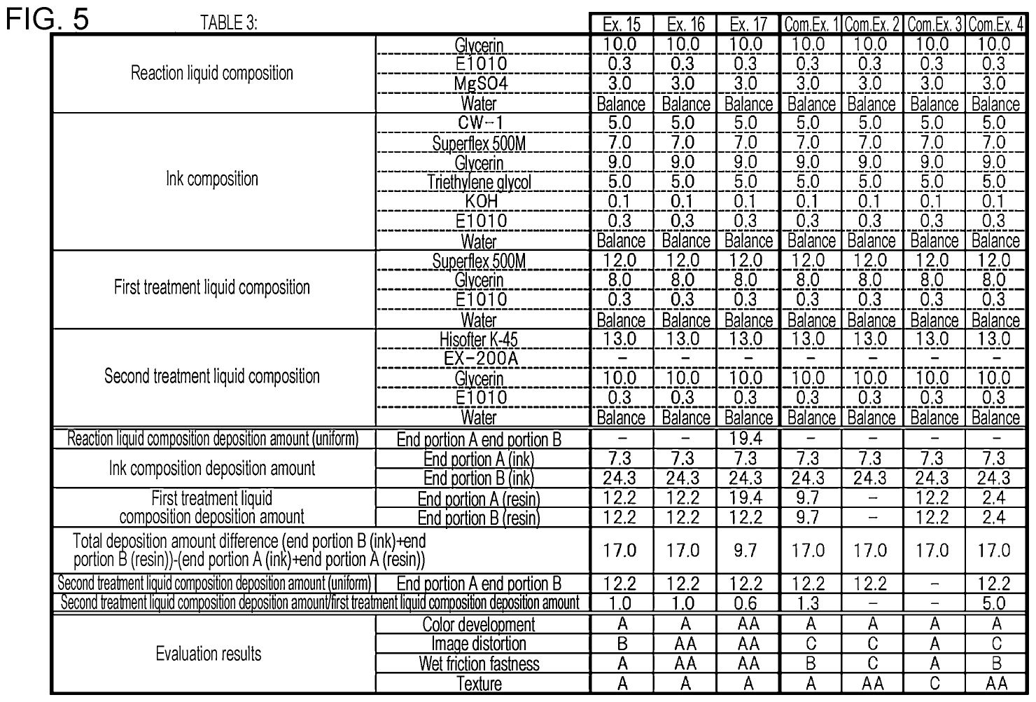

An example of an ink jet textile printing device (recording device) including an ink jet head, which is applicable to the recording method according to the present embodiment, will be described with reference to FIG. 1.

In FIG. 1, the scale of each layer and the scale of each member are different from the actual scales so that each layer and each member are illustrated in recognizable sizes. In FIG. 1, for convenience of explanation, the X-axis, the Y-axis, and the Z-axis are illustrated as three axes orthogonal to one another, and the tip side and the base end side of an arrow indicating the direction of each axis are referred to as “+side” and “−side,” respectively. A direction parallel to the X-axis is referred to as the “X-axis direction,” a direction parallel to the Y-axis is referred to as the “Y-axis direction,” and a direction parallel to the Z-axis is referred to as the “Z-axis direction.”

### 2. 1. Schematic Overview Configuration

FIG. 1 is a schematic diagram illustrating an overview configuration of a recording device 100. First, the overall configuration of the recording device 100 will be described with reference to FIG. 1.

As illustrated in FIG. 1, the recording device 100 includes a medium transport section 20, a medium adhesion section 60, a belt support section 91, a printing section 40, a heating unit 27, a cleaning unit 50, and the like. In the recording device 100, at least one of the medium adhesion section 60 and the belt support section 91 corresponds to a heating section that heats an endless belt 23. The recording device includes a control section 1 that controls each of these parts. Each part of the recording device 100 is attached to a frame section 90.

In the case where the heating section that heats the endless belt is provided, the heating section may be provided on the upstream side of the printing section 40 in the transport direction, and may be provided at a site different from the medium adhesion section 60 and the belt support section 91. For example, the heating section may be on the upstream side of the medium adhesion section 60 in the transport direction. With such a configuration, the heating section can also dry the endless belt 23 which wets during cleaning. The heating section may heat the endless belt in a non-contact manner.

The medium transport section 20 transports fabric 95 in the transport direction. The medium transport section 20 includes a medium supply section 10, transport rollers 21 and 22, the endless belt 23, a belt rotary roller 24, a belt driving roller 25 as a driving roller, transport rollers 26 and 28, and a medium collection section 30.

### 2. 2. Medium Transport Section

First, a transport path of the fabric 95 from the medium supply section 10 to the medium collection section 30 will be described. In FIG. 1, a direction along the direction in which gravity acts is defined as the Z-axis direction, a direction in which the fabric 95 is transported in the printing section 40 is defined as the +X-axis direction, and a width direction of the fabric 95 intersecting both the Z-axis direction and the X-axis direction is defined as the Y-axis direction. The positional relationship along the transport direction of the fabric 95 or the moving direction of the endless belt 23 is also represented by the “upstream side” or the “downstream side.”

The medium supply section 10 supplies the fabric 95 on which an image is formed to the printing section 40 side. The medium supply section 10 has a supply shaft section 11 and a bearing section 12. The supply shaft section 11 is formed in a cylindrical or columnar shape, and is provided to be rotatable in a circumferential direction. The fabric 95 having a band-like shape is wound around the supply shaft section 11 in a roll form. The supply shaft section 11 is detachably attached to the bearing section 12. Consequently, the fabric 95 wound around the supply shaft section 11 in advance can be attached to the bearing section 12 together with the supply shaft section 11.

The bearing section 12 rotatably supports both ends of the supply shaft section 11 in the axial direction. The medium supply section 10 has a rotary driving section (not shown) that rotationally drives the supply shaft section 11. The rotary driving section rotates the supply shaft section 11 in a direction in which the fabric 95 is fed. The operation of the rotary driving section is controlled by the control section 1. The transport rollers 21 and 22 relay the fabric 95 from the medium supply section 10 to the endless belt 23.

The endless belt 23 is held between at least two rollers that rotate the endless belt 23, and transports the fabric 95 in the transport direction (+X-axis direction) while supporting the fabric 95 as the endless belt 23 rotationally moves. Specifically, the endless belt 23 is a seamless belt formed by seamlessly connecting both end portions of a band-shaped belt, and is spanned between two rollers of the belt rotary roller 24 and the belt driving roller 25.

The endless belt 23 is held in a state in which a predetermined tension is applied so that a portion between the belt rotary roller 24 and the belt driving roller 25 becomes horizontal. An adhesive 29 that adheres the fabric 95 is applied to a surface (support surface) 23a of the endless belt 23. That is, the endless belt 23 has an adhesive layer formed from the adhesive 29. The fabric 95 is attached to the endless belt 23 via the adhesive 29. The endless belt 23 supports (holds) the fabric 95 that is supplied from the transport roller 22 and is in close contact with the adhesive 29 in the medium adhesion section 60 described later.

The adhesiveness of the adhesive 29 is preferably increased through heating. The fabric 95 can be favorably adhered to the adhesive layer by using the adhesive 29 the adhesiveness of which increases through heating. Examples of the adhesive 29 include a hot-melt adhesive containing a thermoplastic elastomer SIS (styrene-isoprene-styrene) as a main component.

The belt rotary roller 24 and the belt driving roller 25 support an inner peripheral surface 23b of the endless belt 23. An abutting section 69 that supports the endless belt 23, the belt support section 91, and a platen 46 are provided between the belt rotary roller 24 and the belt driving roller 25. The abutting section 69 is provided in a region facing, via the endless belt 23, a pressing section 61 described later, the platen 46 is provided in a region facing, via the endless belt 23, the printing section 40, and the belt support section 91 is provided between the abutting section 69 and the platen 46. As the abutting section 69, the belt support section 91, and the platen 46 support the endless belt 23, vibration or the like of the endless belt 23 caused when the endless belt 23 is moved can be suppressed.

The belt driving roller 25 is a driving section that transports the fabric 95 in the transport direction by rotating the endless belt 23, and has a motor (not shown) that rotationally drives the belt driving roller 25. The belt driving roller 25 is provided on the downstream side of the printing section 40 in the transport direction of the fabric 95, and the belt rotary roller 24 is provided on the upstream side of the printing section 40. When the belt driving roller 25 is rotationally driven, the endless belt 23 rotates along with the rotation of the belt driving roller 25, and the belt rotary roller 24 is rotated by the rotation of the endless belt 23. By the rotation of the endless belt 23, the fabric 95 supported by the endless belt 23 is transported in the transport direction (+X-axis direction), and an image is formed on the fabric 95 in the printing section 40 described later.

In the example illustrated in FIG. 1, the fabric 95 is supported on the side (+Z-axis side) where the surface 23a of the endless belt 23 faces the printing section 40, and the fabric 95 is transported from the belt rotary roller 24 side to the belt driving roller 25 side together with the endless belt 23. Meanwhile, on the side (−Z-axis side) where the surface 23a of the endless belt 23 faces the cleaning unit 50, only the endless belt 23 moves from the belt driving roller 25 side to the belt rotary roller 24 side.

The transport roller 26 peels off, from the adhesive 29 of the endless belt 23, the fabric 95 on which an image has been formed. The transport rollers 26 and 28 relay the fabric 95 from the endless belt 23 to the medium collection section 30.

The medium collection section 30 collects the fabric 95 transported by the medium transport section 20. The medium collection section 30 has a wind-up shaft section 31 and a bearing section 32. The wind-up shaft section 31 is formed in a cylindrical shape or a columnar shape, and is provided so as to be rotatable in the circumferential direction. The band-shaped fabric 95 is wound around the wind-up shaft section 31 in a roll form. The wind-up shaft section 31 is detachably attached to the bearing section 32. Consequently, the fabric 95 wound around the wind-up shaft section 31 can be removed together with the wind-up shaft section 31.

The bearing section 32 rotatably supports both ends in the axial direction of the wind-up shaft section 31. The medium collection section 30 has a rotary driving section (not shown) that rotationally drives the wind-up shaft section 31. The rotary driving section rotates the wind-up shaft section 31 in a direction in which the fabric 95 is wound. The operation of the rotary driving section is controlled by the control section 1.

Next, the heating section, the printing section 40, the heating unit 27, and the cleaning unit 50 provided along the medium transport section 20 will be described.

### 2. 3. Heating Section

At least one of the abutting section 69 and the belt support section 91 is preferably provided with a heater that heats the endless belt 23. The heater constitutes the heating section. The case where the abutting section 69 is provided with the heater is preferable because pressing force and heat can be applied to the endless belt 23 by the pressing section 61, adhesiveness of the fabric 95 to the endless belt 23 can thus be improved. Therefore, when one of the abutting section 69 and the belt support section 91 is provided with the heater, it is more preferable that the abutting section 69 be provided with the heater.

The heating section heats the adhesive layer to soften the adhesive layer and bring about adhesiveness, thereby improving adhesiveness between the fabric 95 and the adhesive layer. As a result, the fabric 95 is prevented from moving on the endless belt 23, and good transport accuracy can be obtained.

When at least one of the abutting section 69 and the belt support section 91 is provided with the heater, and the endless belt 23 is heated, the temperature of the surface 23a of the endless belt 23 is preferably 80 degrees or lower, more preferably 70° C. or lower, and still more preferably 60° C. or lower. When the temperature of the surface 23a of the endless belt 23 is within the above ranges, reactivity of the resin particles included in the ink composition may be suppressed, and the belt may be more easily cleaned. The lower limit of the temperature of the surface 23a of the endless belt 23 may be any temperature as long as the adhesiveness of the adhesive layer is exhibited, and is preferably 30° C. or higher, more preferably 35° C. or higher, and still more preferably 40° C. or higher. Incidentally, the temperature of the surface 23a of the endless belt 23 can be measured by, for example, a radiation-type thermometer, a contact-type thermometer, or the like, and is more preferably measured by a radiation-type thermometer.

When at least one of the abutting section 69 and the belt support section 91 is provided with the heater, a temperature detection section (not shown) that detects the surface temperature of the endless belt 23 may be provided. As the temperature detection section, for example, a thermocouple or the like can be used. Consequently, the control section 1 can control the heater on the basis of the temperature detected by the temperature detection section to set the temperature of the endless belt 23 to a predetermined temperature. Note that a non-contact type thermometer using infrared rays may be used as the temperature detection section.

### 2. 4. Printing Section

The printing section 40 is disposed above (on the +Z axis side) the position at which the endless belt 23 is disposed, and performs printing on the fabric 95 placed on the surface 23a of the endless belt 23. The printing section 40 has an ink jet head 42, a carriage 43 on which the ink jet head 42 is mounted, and a carriage moving section 45 that moves the carriage 43 in the width direction (Y-axis direction) of the fabric 95 intersecting the transport direction.

The ink jet head 42 is a unit that splays a liquid composition supplied from a liquid cartridge (not shown) to the fabric 95 from a plurality of nozzles under the control of the control section 1 to deposit the liquid composition onto the fabric 95. The ink jet head 42 is provided with the plurality of nozzles that discharges the liquid composition toward the fabric 95 onto which the liquid composition is deposited to deposit the liquid composition onto the fabric 95. The plurality of nozzles is arranged in a row to form a nozzle row, and the nozzle row is individually arranged to correspond to the liquid composition. The liquid composition is supplied from each liquid cartridge to the ink jet head 42, and is discharged as droplets from a nozzle by an actuator (not shown) in the ink jet head 42. The discharged droplets of the liquid composition land on the fabric 95, and an image, a text, a pattern, a color, and the like are formed in the textile printing region of the fabric 95.

The liquid composition herein can be the softening liquid composition, the coating liquid composition, the ink composition, or the reaction liquid composition described above. The type and number of these liquid compositions can be appropriately set.

Although a piezoelectric element is used as the actuator, which is a driving unit, for the ink jet head 42, the method is not limited thereto. For example, an electromechanical transducer that displaces a diaphragm as the actuator by electrostatic adsorption, or an electrothermal transducer that discharges the liquid composition or the like as droplets by bubbles generated through heating may be used.

The carriage moving section 45 is provided above (on the +Z axis side of) the endless belt 23. The carriage moving section 45 has a pair of guide rails 45a and 45b extending along the Y-axis direction. The ink jet head 42 is supported by the guide rails 45a and 45b in a state in which the ink jet head 42 can reciprocate along the Y-axis direction together with the carriage 43.

The carriage moving section 45 includes a moving mechanism and a power source, which are not shown. As the moving mechanism, for example, a mechanism in which a ball screw and a ball nut are combined, a linear guide mechanism, or the like can be employed. Further, the carriage moving section 45 has a motor (not shown) as a power source for moving the carriage 43 along the guide rails 45a and 45b. As the motor, various motors such as a stepping motor, a servo motor, or a linear motor can be employed. When the motor is driven under the control of the control section 1, the ink jet head 42 moves along the Y-axis direction together with the carriage 43.

### 2. 5. Heating Unit

The heating unit 27 may be provided between the transport roller 26 and the transport roller 28. The heating unit 27 heats the ink composition, the softening liquid composition, and the coating liquid composition discharged onto the fabric 95. Consequently, the reaction of the resin particles contained in the ink composition tends to sufficiently proceed. When the resin particles sufficiently react, an image with good friction fastness may be formed. The heating unit 27 may be used for the purpose of drying the fabric 95. The heating unit 27 includes, for example, an IR heater, and the ink composition or the coating liquid composition discharged onto the fabric 95 can be reacted in a short time by driving the IR heater. Consequently, the band-shaped fabric 95 on which an image or the like is formed can be wound around the wind-up shaft section 31.

### 2. 6. Cleaning Unit

The cleaning unit 50 is disposed between the belt rotary roller 24 and the belt driving roller 25 in the X-axis direction. The cleaning unit 50 has a cleaning section 51, a pressing section 52, and a moving section 53. The moving section 53 integrally moves the cleaning unit 50 along a floor surface 99 and fixes the cleaning unit 50 at a predetermined position.

The pressing section 52 is, for example, an elevating and lowering device composed of an air cylinder 56 and a ball bush 57, and brings the cleaning section 51 provided above the pressing section 52 into contact with the surface 23a of the endless belt 23. The cleaning section 51 cleans, from below (−Z-axis direction), the surface (supporting surface) 23a of the endless belt 23 which is spanned between the belt rotary roller 24 and the belt driving roller 25 in a state in which a predetermined tension is applied thereto and moves from the belt driving roller 25 toward the belt rotary roller 24.

The cleaning section 51 has a cleaning tank 54, a cleaning roller 58, and a blade 55. The cleaning tank 54 is a tank that stores a cleaning liquid used to clean ink or foreign matter attaching to the surface 23a of the endless belt 23, and the cleaning roller 58 and the blade 55 are provided inside the cleaning tank 54. As the cleaning liquid, for example, water or a water-soluble solvent (alcohol aqueous solution or the like) can be used, and a surfactant and a defoaming agent may be added as necessary.

When the cleaning roller 58 rotates, the cleaning liquid is supplied to the surface 23a of the endless belt 23, and the cleaning roller 58 and the endless belt 23 slide. Consequently, the ink composition attached to the endless belt 23, fibers of the fabric 95, and the like are removed by the cleaning roller 58.

The blade 55 can be formed from, for example, a flexible material such as silicone rubber. The blade 55 is provided on the downstream side of the cleaning roller 58 in the transport direction of the endless belt 23. The cleaning liquid remaining on the surface 23a of the endless belt 23 is removed as the endless belt 23 and the blade 55 slide.

According to such a recording device 100, the recording method of the present embodiment can be easily executed.

### 3. Examples and Comparative Examples

Hereinafter, the present disclosure will be specifically described with reference to Examples, but the present disclosure is not limited to these Examples. Hereinafter, “parts” and “%” are based on mass unless otherwise described. Evaluation was performed in an environment at a temperature of 25° C. and a relative humidity of 40.0% unless otherwise specified.

### 3. 1. Preparation of Each Composition

A reaction liquid composition, an ink composition, a first treatment liquid composition, and a second treatment liquid composition were prepared as follows. The respective components were placed in a container so as to achieve each composition shown in Table 1, and mixed and stirred for 2 hours with a magnetic stirrer, followed by filtration through a membrane filter having a pore size of 5 μm to obtain the reaction liquid composition, the ink composition, the first treatment liquid composition, and the second treatment liquid composition used in each of Examples and Comparative Examples. The numerical values in the table represent solid contents.

The abbreviations and product names shown in Table 1 will be further described.
E1010: OLFINE E1010, acetylene glycol-based surfactant manufactured by Nissin Chemical Industry Co., Ltd.
MgSO4: Magnesium sulfate (polyvalent metal salt)
CW-1: Bonjetblack CW-1 (manufactured by ORIENT CHEMICAL INDUSTRIES CO., LTD.) pigment dispersion
SUPERFLEX 500M manufactured by DKS Co. Ltd., urethane-based resin emulsion
HISOFTER K-45: dimethyl silicone-based softening agent manufactured by Meisei Chemical Works, Ltd.
EX-200A: polyester-based softening agent manufactured by TAKAMATSU OIL & FAT CO., LTD.

### 3. 2. Evaluation Method

### 3. 2. 1. Printing Test

A square pattern of a 30 cm square was printed using an ink composition (black ink). The duty at both ends of the pattern was set to be different from each other, the duty was set to be uniformly controlled so that gradation printing can be performed, and printing was performed with the deposition amounts (mL/m²) shown in Tables 1 to 3. FIG. 2 schematically shows a square pattern of the ink composition. As shown in FIG. 2, the side on which the duty is small is referred to as an end portion A, and the side on which the duty is large is referred to as an end portion B.

The duty of the first treatment liquid composition was also set to allow control similar to that for the ink composition, and printing was performed with the deposition amounts (mL/m²) shown in Tables 1 to 3. Tables 1 to 3 show the deposition amount at each end portion.

In every case, the deposition amount was set to 24.3 mL/m² when printing was performed at a duty of 100%.

In Examples 8 and 17 using the reaction liquid composition, the deposition amount (duty) was uniform over the entire image region. Also in the examples using the second treatment liquid composition, the deposition amount (duty) was uniform over the entire image region.

The type of cloth used was 100% cotton in Examples 16 and 17, and all other Examples used blended fabric (PES 35%, cotton/polyester blend).

In each of the Examples, printing evaluation was performed using a modified ML-8000 machine using the compositions shown in Tables 1 to 3. The printing resolution was 1200×1200 dpi.

The drying temperature (surface temperature of fabric) was 135° C. in Example 14, and 165° C. in Example 15. In all other Examples, the temperature was 150° C. The drying time was 2 minutes in all Examples. The drying unit was a gas oven in Examples 13 and 17, and was an IR heater in other Examples.

### 3. 2. 2. Evaluation of Color Development

Printing evaluation was performed using a modified ML-8000 machine. The resolution of printing was 1200×1200 dpi, and an image with a duty of 100% was separately printed with the composition used in each of Examples, and the OD value after drying at 160° C. for 3 minutes was measured. The OD values were evaluated according to the following criteria. Results thereof are shown in tables.
AA: OD value is 1.55 or more
A: OD value is 1.50 or more and less than 1.55
B: OD value is less than 1.50

### 3. 2. 3. Evaluation of Image Distortion

The length of the end portion A and the length of the end portion B of the pattern obtained in each of Examples were compared. The differences were evaluated according to the following criteria. Results thereof are shown in tables.
AA: difference in length is less than 0.5% of length of end portion A
A: difference in length is 0.5% or more and less than 1% of length of end portion A
B: difference in length is 18 or more and less than 3% of length of end portion A
C: difference in length is 3% or more of length of end portion A

### 3. 2. 4. Evaluation of Wet Friction Fastness

The printed matter of each of Examples was evaluated according to the standard of ISO105 X12. The results were evaluated according to the following criteria and shown in tables.
AA: grades 3-4 or more
A: grade 3
B: grades 2-3
C: grade 2 or less

### 3. 2. 5. Evaluation of Texture

The shear hardness (gf/cm/deg) of the printed material of each of Examples was evaluated using Tensile and Shear tester KES-FB1-A from KATO TECH CO., LTD. The shear hardnesses were evaluated according to the following criteria. Results thereof are shown in tables. Note that
“AA*” in Example 7 indicates that although the shear hardness was good, sliminess occurred.
AA: shear hardness is less than 6 (gf/cm/deg) A: shear hardness is 6 (gf/cm/deg) or more and less than 8 (gf/cm/deg)
B: shear hardness is 8 (gf/cm/deg) or more and less than 10 (gf/cm/deg)
C: shear hardness is 10 (gf/cm/deg) or more

### 3. 3. Evaluation Results

As seen in the tables, it was found that the recorded matter obtained by the recording method of each of Examples had good fastness and good texture, and an image distortion was reduced, the recording method of each of Examples including a color ink deposition step of depositing an ink composition containing a pigment, resin particles, and water onto a recording medium by an ink jet method to form an image region, a first treatment liquid deposition step of depositing a first treatment liquid composition containing resin particles and water onto the recording medium by an ink jet method, and a second treatment liquid deposition step of depositing a second treatment liquid composition containing a softening agent onto the recording medium by an ink jet method, in which the image region had regions with different ink deposition amounts per unit area, the first treatment liquid deposition step and the second treatment liquid deposition step were carried out for at least the entire image region, and the deposition amount of the first treatment liquid composition was 12 mL/m² or more.

The present disclosure includes a configuration substantially the same as the configuration described in the embodiment, for example, a configuration having the same function, method, and result, or a configuration having the same object and effect. In addition, the present disclosure includes a configuration in which a non-essential portion of the configuration described in the embodiment is replaced. In addition, the present disclosure includes a configuration that provides the same function and effect or a configuration that can achieve the same object as the configuration described in the embodiment. Further, the present disclosure includes a configuration in which a known feature is added to the configuration described in the embodiment.

The following contents are derived from the above-described embodiment and modifications.

A recording method includes a color ink deposition step of depositing an ink composition containing a pigment, resin particles, and water onto a recording medium by an ink jet method to form an image region, a first treatment liquid deposition step of depositing a first treatment liquid composition containing resin particles and water onto the recording medium by an ink jet method, and a second treatment liquid deposition step of depositing a second treatment liquid composition containing a softening agent onto the recording medium by an ink jet method, in which the image region has regions with different ink deposition amounts per unit area, the first treatment liquid deposition step and the second treatment liquid deposition step are carried out for at least the entire image region, and the deposition amount of the first treatment liquid composition is 12 mL/m² or more.

According to this recording method, since the resin particles are included in the ink composition, a recorded matter with good friction fastness is obtained. When 12 mL/m² or more of the first treatment liquid composition is deposited onto the image region, the difference in shrinkage between the image region and the deposition region of the first treatment liquid composition becomes small, and an image distortion image can be suppressed. Further, by further depositing the second treatment liquid composition, the texture of the recorded matter can also be improved.

In the above-described recording method, the content of the resin particles in the first treatment liquid composition may be 80% by mass or more based on the total amount of nonvolatile components in the first treatment liquid composition.

According to this recording method, a recorded matter with better friction fastness is obtained.

In the above-described recording method, the content of the softening agent in the second treatment liquid composition may be 60% by mass or more based on the total amount of nonvolatile components in the second treatment liquid composition.

According to this recording method, a recorded matter with better texture is obtained.

In the above-described recording method, the difference in the sum of the deposition amount of the ink composition and the deposition amount of the first treatment liquid composition per unit area between the region where the sum is maximum and the region where the sum is minimum in the image region may be 10 mL/m² or less.

According to this recording method, since the sum of the deposition amount of the ink composition and the deposition amount of the first treatment liquid composition is substantially uniform in the image region, an image distortion can be further suppressed.

In the above-described recording method, the deposition amount of the second treatment liquid composition may be equal to or greater than one half of the deposition amount of the first treatment liquid composition.

According to this recording method, a recorded matter with better texture is obtained.

In the above-described recording method, the softening agent may be a dimethyl silicone-based softening agent.

According to this recording method, a recorded matter with better texture is obtained.

In the above-described recording method, the content of the softening agent may be 8% by mass or more and 15% by mass or less based on the total amount of the second treatment liquid composition.

According to this recording method, a recorded matter with better texture is obtained.

The above-described recording method may further include a reaction liquid deposition step of depositing a reaction liquid composition containing an aggregating agent aggregating the components in the ink composition onto the recording medium.

According to this recording method, a recorded matter with better color developability is obtained.

In the above-described recording method, the content of the resin particles in the ink composition may be 4% by mass or more and 8% by mass or less based on the total amount of the ink composition, and the content of the resin particles in the first treatment liquid composition may be 10% by mass or more and 15% by mass or less based on the total amount of the first treatment liquid composition.

According to this recording method, the difference in shrinkage between the image region and the deposition region of the first treatment liquid composition is easily made small, and an image distortion is more easily suppressed.

The above-described recording method may further include a step of heating and drying.

According to this recording method, when an image distortion is likely to occur due to heating and drying, the effect of reducing a distortion can be more significantly provided.

In the above-described recording method, heating may be performed such that the surface temperature of the recording medium becomes 150° C. or higher and 160° C. or lower in the heating and drying.

According to this recording method, when an image distortion is likely to occur due to heating and drying, the effect of reducing a distortion can be more significantly provided.

In the above-described recording method, the recording medium may be fabric.

According to this recording method, when an image is recorded on fabric on which an image distortion is likely to occur, the effect of reducing a distortion can be more significantly provided.

In the above-described recording method, the recording medium may be cotton fabric.

According to this recording method, when an image is recorded on cotton fabric on which an image distortion is likely to occur, the effect of reducing a distortion can be more significantly provided.

What is claimed is:

1. A recording method comprising:
a color ink deposition step of depositing an ink composition containing a pigment, resin particles, and water onto a recording medium by an ink jet method to form an image region;
a first treatment liquid deposition step of depositing a first treatment liquid composition containing resin particles and water onto the recording medium by an ink jet method; and
a second treatment liquid deposition step of depositing a second treatment liquid composition containing a softening agent onto the recording medium by an ink jet method, wherein
the image region has regions with different ink deposition amounts per unit area,
the first treatment liquid deposition step and the second treatment liquid deposition step are carried out for at least an entire image region, and
a deposition amount of the first treatment liquid composition is 12 mL/m² or more.

2. The recording method according to claim 1, wherein
a content of the resin particles in the first treatment liquid composition is 80% by mass or more based on a total amount of nonvolatile components in the first treatment liquid composition.

3. The recording method according to claim 1, wherein
a content of the softening agent in the second treatment liquid composition is 60% by mass or more based on a total amount of nonvolatile components in the second treatment liquid composition.

4. The recording method according to claim 1, wherein
a difference in a sum of a deposition amount of the ink composition and a deposition amount of the first treatment liquid composition per unit area between a region where the sum is maximum and a region where the sum is minimum in the image region is 10 mL/m² or less.

5. The recording method according to claim 1, wherein
a deposition amount of the second treatment liquid composition is equal to or greater than one half of a deposition amount of the first treatment liquid composition.

6. The recording method according to claim 1, wherein
the softening agent is a dimethyl silicone-based softening agent.

7. The recording method according to claim 1, wherein
a content of the softening agent is 8% by mass or more and 15% by mass or less based on a total amount of the second treatment liquid composition.

8. The recording method according to claim 1, further comprising a reaction liquid deposition step of depositing a reaction liquid composition containing an aggregating agent aggregating components in the ink composition onto the recording medium.

9. The recording method according to claim 1, wherein
a content of the resin particles in the ink composition is 4% by mass or more and 8% by mass or less based on a total amount of the ink composition, and a content of the resin particles in the first treatment liquid composition is 10% by mass or more and 15% by mass or less based on a total amount of the first treatment liquid composition.

10. The recording method according to claim 1, further comprising a step of heating and drying.

11. The recording method according to claim 10, wherein
heating is performed such that a surface temperature of the recording medium becomes 150° C. or higher and 160° C. or lower in the heating and drying.

12. The recording method according to claim 1, wherein
the recording medium is fabric.

13. The recording method according to claim 12, wherein
the recording medium is cotton fabric.
